(19) United States
(12) Patent Application Publication
(10) Pub. No.: US 2026/0264209 A1
(43) Pub. Date: Sep. 10, 2026

(54) Self-Contained Modular Rotary / Reciprocal / Vibratory Movement Multi-Purpose Tool Apparatus

(71) Applicant: Terry Sandefur, Bayfield, CO (US)

(72) Inventor: Terry Sandefur, Bayfield, CO (US)

(21) Appl. No.: 19/553,212

(22) Filed: Feb. 28, 2026

Related U.S. Application Data
(60) Provisional application No. 63/766,940, filed on Mar. 4, 2025.

(51) Int. Cl. B25F 3/00; B25F 5/02

(52) U.S. Cl. CPC B25F 3/00; B25F 5/029

(57) ABSTRACT

A self-contained modular rotary/reciprocal/vibratory movement multi-purpose tool apparatus for cutting, drilling, trimming, sanding, polishing, or massaging utilizing a plurality of tool pieces for work upon an article, the apparatus includes a core first module with a surrounding sidewall with a motor disposed therein, wherein the motor is rotationally engaged to a speed reduction transmission that is also disposed within the core, wherein the speed reduction transmission has a speed reduction transmission output shaft that has a first means for rotational removable engagement to drive the tool piece for the cutting, drilling, trimming, sanding, polishing, or massaging functions.

### CROSS-REFERENCE TO RELATED APPLICATION

This patent application claims the benefit of U.S. provisional patent application Ser. No. 63/766,940 filed on Mar. 4, 2025, by Terry Sandefur of Bayfield, Colorado U.S.

### BACKGROUND OF INVENTION

The present invention allows the rapid and easy customization of a handheld power tool utilizing cordless rechargeable battery technology, essentially being multiple tools in one tool equaling less bulk, weight, and cost, all while accomplishing numerous tool functions that really have no limit.

The present invention relates to a self-contained modular rotary/reciprocal movement multi-purpose tool apparatus including a hand hold handle third module that can be selectably rotationally lockably coupled to a first, a second, and a fourth module that selectably respectively contain a motor, a transmission, a power source, a rotary head, a reciprocating head, and a rotary spindle, wherein the aforementioned modules are all removably engageable to one another to enable a custom build hand-held power tool through selective module use that can accomplish functionally what it currently takes multiple separate tools to do. Further included are built in multiple storage containers for tool pieces and variable amounts of rechargeable battery power packs available for the power source, the tool pieces accommodate to include the functions of but not limited to cutting, drilling, trimming, sanding, polishing, massaging, reciprocating saw, a hex bit, T-slot saw, needle file, grill brush, grill grate scrapper, chisel, scrapping blade, circular saw, angle grinder, air blower, chain saw, belt sander, angle sander, coffee grinder, pump, weed eater, wire brush, and torque driver.

The advantages of the present invention are many, starting with not needing different battery configurations (plus the need for matching battery chargers for each required battery configuration), for each tool used, the ability to “stack-up” for additional battery power levels for longer tool use needs, this is in addition to time savings for performing entirely different tool functions via having the different modules at hand to selectively assembly for the particular desired tool function, as opposed to searching for different separate tools usually requiring their own unique batteries and accompanying mandatory matching chargers. Further, when the technician goes to a work site they don't have to worry as much on remembering all the different power tools that they will need as they will only typically need the present invention that has the capability to perform multiple tool functions that they will need on the job site, resulting in making the technicians work easier, especially in the instance where the technician in working in a remote mobile manner out of a van fir instance, wherein multiple tool space availability is limited, and made worse for needing extra space for different battery packs and their dedicated chargers.

### SUMMARY OF THE INVENTION

Broadly, the present invention is the self-contained modular rotary/reciprocal/vibratory movement multi-purpose tool apparatus, the multi-purpose tool apparatus is for cutting, drilling, trimming, sanding, polishing, or massaging utilizing a plurality of tool pieces for work upon an article, the multi-purpose tool apparatus includes a core first module that has a core first end portion and an opposing core second end portion with a core longitudinal axis spanning therebetween, the core first module also includes a core surrounding sidewall with a core surrounding sidewall outer surface and an opposing core surrounding sidewall inner surface, the core module further includes a core first module interior that is defined by the core first module surrounding sidewall inner surface and the first and second core end portions, the core first module further includes a motor with an energy source that is disposed within the core first module interior, the motor has a motor primary end portion and an opposing motor secondary end portion with a motor rotational axis disposed therebetween, wherein the motor secondary end portion further includes a first plurality of removably engageable electrical communications, wherein the motor further has a body portion that is disposed between the motor primary end portion and the motor secondary end portion, the motor body portion further includes a second plurality of removably engageable electrical communications that are disposed upon an external portion of the motor body portion.

Wherein, on the multi-purpose tool apparatus, the core longitudinal axis and the motor rotational axis are substantially coincident to one another, the motor primary end portion further includes a primary motor output shaft that is rotationally engaged to a speed reduction transmission through a speed reduction transmission input shaft, wherein the speed reduction transmission has a speed reduction transmission output shaft that has a first means for rotational removable engagement disposed at the core first end portion, the speed reduction transmission is disposed within the core first end portion, the motor secondary end portion further includes a direct motor output shaft having a second means for rotational removable engagement disposed at the core second end portion, the core first end portion has a third means for removable engagement and the core second end portion has a fourth means for removable engagement, the core surrounding sidewall further includes a first interface that is disposed therethrough from the core surrounding sidewall outer surface to the core surrounding sidewall inner surface, the first interface is about an extension axis that is positioned substantially perpendicular to the core longitudinal axis.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows an upper perspective assembly view of the self-contained modular rotary/reciprocal/vibratory movement multi-purpose tool apparatus that includes the core first module, plus the first auxiliary power second module and its accessory end portion, the fourth module structure and its output shaft, and further the second auxiliary power third module and its peripheral end portion;

FIG. 2 shows an exploded upper perspective dis-assembly view of the self-contained modular rotary/reciprocal/vibratory movement multi-purpose tool apparatus that includes the core first module, plus the first auxiliary power second module and its accessory end portion, the fourth module structure and its output shaft, and further the second auxiliary power third module and its peripheral end portion, in addition the motor and the speed reduction transmission are shown;

FIG. 3 shows an exploded side elevation cross-section dis-assembly view of the self-contained modular rotary/reciprocal/vibratory movement multi-purpose tool apparatus that includes the core first module, plus the first auxiliary power second module and its accessory end portion, the fourth module structure and its output shaft, and further the second auxiliary power third module and its peripheral end portion, in addition the motor and the speed reduction transmission, further to the rotary to reciprocal fourth module structure that are shown;

FIG. 4 shows a partially exploded side elevation cross-section dis-assembly view of the self-contained modular rotary/reciprocal/vibratory movement multi-purpose tool apparatus that includes the core first module, the first auxiliary container structure, the rotary spindle fifth module structure and its output end portion, and further the second auxiliary power third module and its peripheral end portion, in addition the motor and the speed reduction transmission are shown;

FIG. 5 shows an upper perspective view of the rotary couple with slip ring architecture for rotational electrical communication for the second auxiliary power third module at the first interface to the core first module;

FIG. 6 shows the exploded side elevation cross-section dis-assembly view of the self-contained modular rotary/reciprocal/vibratory movement multi-purpose tool apparatus that includes the core first module, plus a plurality of the first auxiliary power second modules electrically connected in parallel, and its accessory end portion, the fourth module structure and its output shaft, and further a plurality of the second auxiliary power third modules electrically connected in parallel, and its peripheral end portions, in addition the motor and the speed reduction transmission, in addition to the rotary to reciprocal fourth module structure is shown;

FIG. 7 shows the exploded side elevation cross-section dis-assembly view of the self-contained modular rotary/reciprocal/vibratory movement multi-purpose tool apparatus that includes the core first module, plus the first auxiliary power second module that is adapted to accommodate a standardized power source from existing manufacturers, the fourth module structure and its output shaft, and further the second auxiliary power third module that is adapted to accommodate a standardized power source from existing manufacturers, in addition the motor and the speed reduction transmission, in addition to the rotary to reciprocal fourth module structure is shown;

FIG. 8 shows the exploded side elevation cross-section dis-assembly view of the self-contained modular rotary/reciprocal/vibratory movement multi-purpose tool apparatus that includes the core first module, plus the first auxiliary power second module and its accessory end portion, the fourth module structure and its output shaft, and further the second auxiliary power third module and its peripheral end portion, in addition the motor and the speed reduction transmission, in addition to a chuck rotational vise for the first means for rotational removable engagement is shown;

FIG. 9 shows the exploded side elevation cross-section dis-assembly view of the self-contained modular rotary/reciprocal/vibratory movement multi-purpose tool apparatus that includes the core first module, plus the first auxiliary power second module and its accessory end portion, the fourth module structure and its output shaft, and further the second auxiliary power third module and its peripheral end portion, in addition the motor and the speed reduction transmission, further shown is the fifth means for reciprocating removable engagement, the reciprocating tool, and the surrounding sidewall safety shroud;

FIG. 10 shows the exploded side elevation cross-section dis-assembly view of the self-contained modular rotary/reciprocal/vibratory movement multi-purpose tool apparatus that includes the core first module, plus the first auxiliary power second module and its accessory end portion, the eighth module right angle rotational drive structure and its input shaft and output shaft, and further the second auxiliary power third module and its peripheral end portion, in addition the motor and the speed reduction transmission;

FIG. 11 shows the exploded side elevation cross-section dis-assembly view of the self-contained modular rotary/reciprocal/vibratory movement multi-purpose tool apparatus that includes the core first module, plus the first auxiliary power second module and its accessory end portion, the sixth module hammer drill and its input shaft and output shaft, and further the second auxiliary power third module and its peripheral end portion, in addition the motor and the speed reduction transmission;

FIG. 12 shows the exploded side elevation cross-section dis-assembly view of the self-contained modular rotary/reciprocal/vibratory movement multi-purpose tool apparatus that includes the core first module, plus the first auxiliary power second module and its accessory end portion, the seventh module impact wrench and its input shaft and output shaft, and further the second auxiliary power third module and its peripheral end portion, in addition the motor and the speed reduction transmission;

FIG. 13 shows an exploded side elevation cross-section dis-assembly view of the self-contained modular rotary/reciprocal/vibratory movement multi-purpose tool apparatus that includes the core first module, plus the first auxiliary power second module and its accessory end portion, the fourth module structure and its output shaft, and further the second auxiliary power third module and its peripheral end portion, in addition the motor and the speed reduction transmission, in addition to the rotary to reciprocal fourth module structure are shown, in addition to the collar structure that includes a switch and a light dimmer, the collar is powered from the first module and powers electrical accessory in the form of an illumination element that illuminates the article;

FIG. 14 shows a remote electronic assembly that is powered from the collar structure, as shown in FIG. 13, in FIG. 14 the remote electronic assembly can be mounted remote in relation to the self-contained modular rotary/reciprocal/vibratory movement multi-purpose tool apparatus, wherein the remote electronic assembly can be an illumination element, or gas detector, motion detector, Bluetooth speaker, and Wi-Fi hotspot;

FIG. 15 shows a first alternative embodiment of the multi-purpose rotary / reciprocal/vibratory movement tool apparatus that has a core second module that includes a motor and energy source that drives a speed reduction transmission that drives the tenth module that create variable reciprocal movement thereby causing the core second module to reciprocally vibrate, further shown is the nineth module that includes a first motor drive with imbalance element and in an opposing position along the core percussion axis is the output end portion of the tenth module that includes the second motor drive with imbalance element;

FIG. 16 shows the wand that optionally replaces the second motor and soft tipped dome massager extension, the wand attaches to the output end portion that is modified of the tenth module to attach to the wand proximal tube end portion, with the third motor driving the imbalance element through a Bowden cable providing rotary imbalance and reciprocating movement at the wand distal at the soft dome tip;

FIG. 17 shows the bench mount for the core first module that removably engages the core second end portion to the workbench surface or through to a workbench vise to secure the self-contained modular rotary/reciprocal/vibratory movement multi-purpose tool apparatus to the workbench or vise to enable the user to use both hands to manipulate the article without having to manually hold the self-contained modular rotary/reciprocal/vibratory movement multi-purpose tool apparatus, such that the first means for removable engagement extends vertically upward;

FIG. 18 shows the bench mount for the core first module that removably engages the peripheral end portion of the second auxiliary power third module that ultimately attaches to the outer surface of the core first module to give an alternate mounting of the self-contained modular rotary/reciprocal/vibratory movement multi-purpose tool apparatus to the workbench surface or through to a workbench vise to secure the self-contained modular rotary/reciprocal/vibratory movement multi-purpose tool apparatus to the workbench or vise to enable the user to use both hands to manipulate the article without having to manually hold the self-contained modular rotary/reciprocal/vibratory movement multi-purpose tool apparatus, positioned such that the first means for removable engagement extends horizontally;

FIG. 19 shows the multiple reciprocating tool receptacle carriage for the fourth module, wherein the receptacle cartridge can hold a variety of reciprocating tools in a circular manner;

FIG. 20 shows the guarded spindle twelfth module in cross section and an end view that is removably engaged to the core first module at the male thread engagement to the first end portion of the core first module, wherein the inner rigid guard rotates in a lockable manner via rotation lock, plus the guarded spindle twelfth module uses a dual sided castellated nut locking ring that is received into the inner back plate guard notches to rotationally lock the safety shroud to the core first module, with the safety shroud being operational as a safety shroud for a rotary spindle with the circular saw as shown; and

FIG. 21 shows a detailed view from FIG. 20 of the dual sided castellated nut locking ring that is received into the inner back plate guard notches in relation to the core first module to rotationally lock the safety shroud in selected rotational positions.

### DETAILED DESCRIPTION OF THE INVENTION

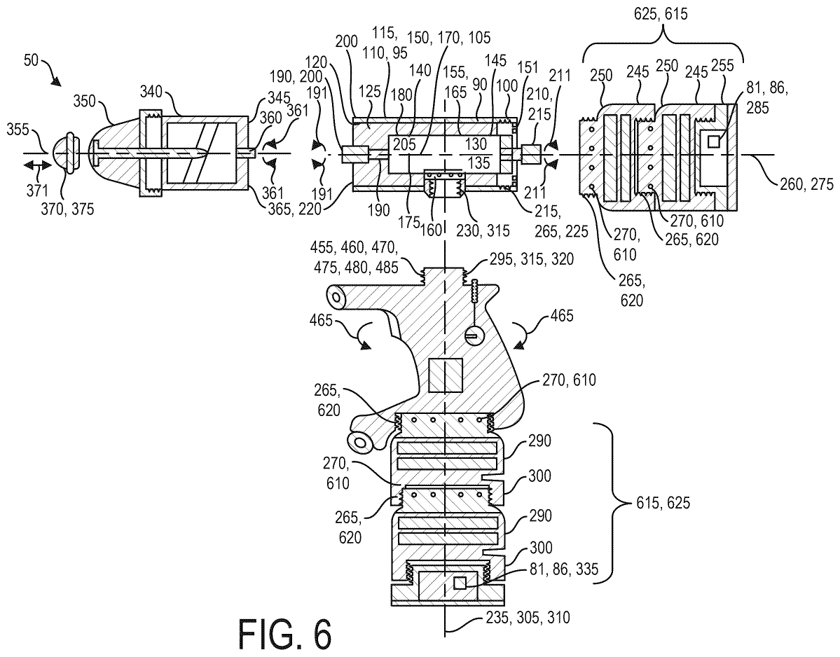

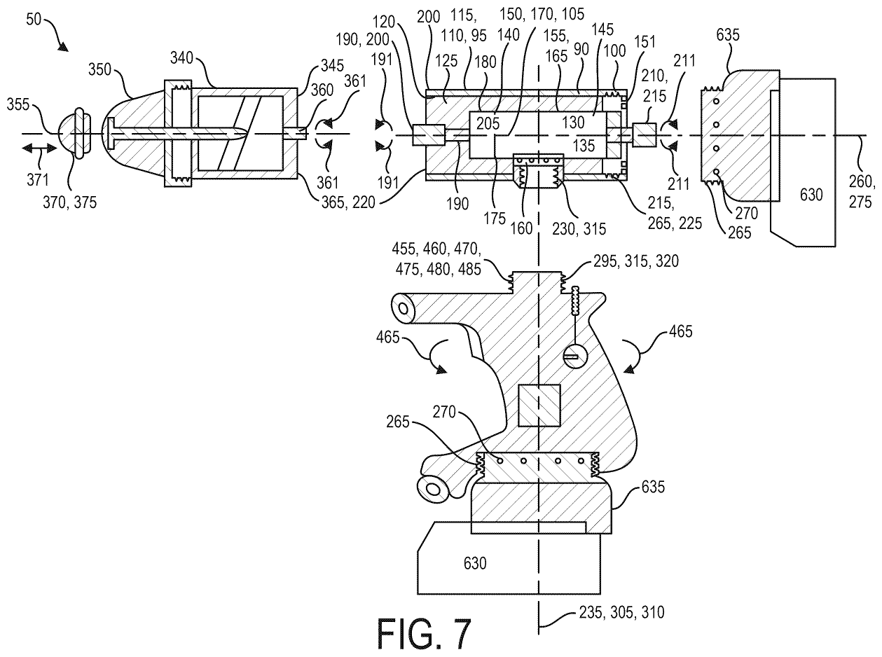

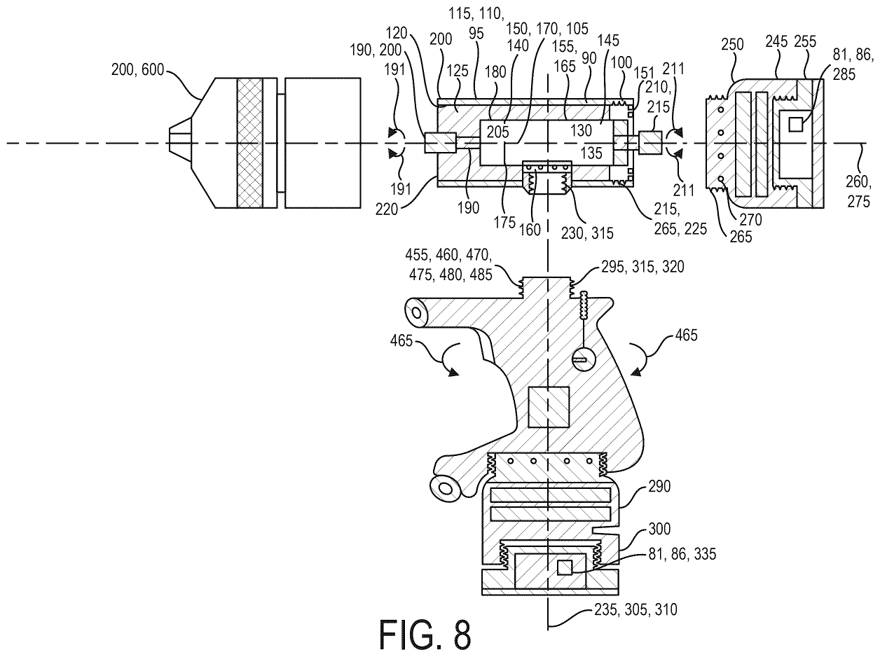

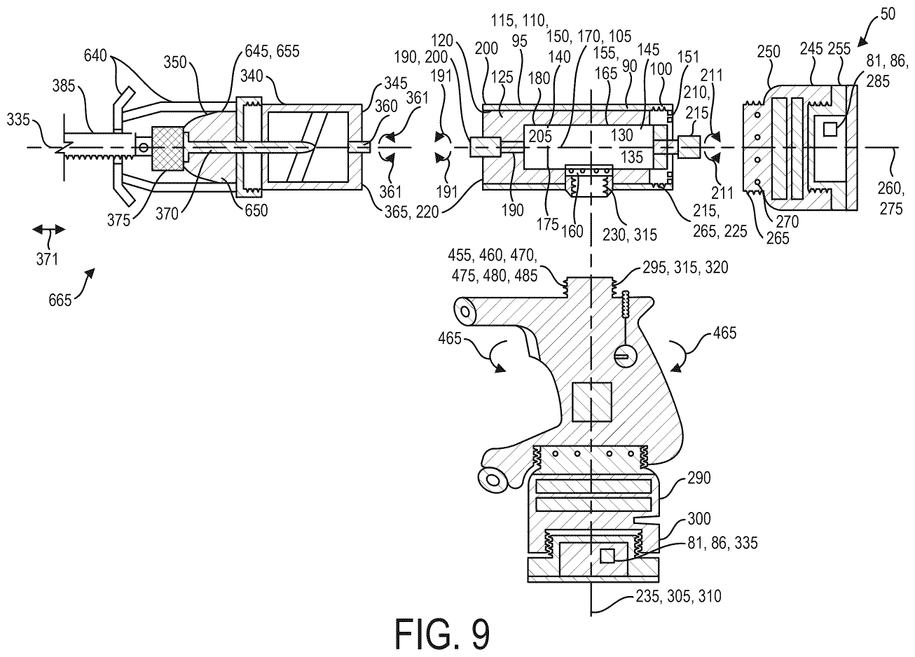

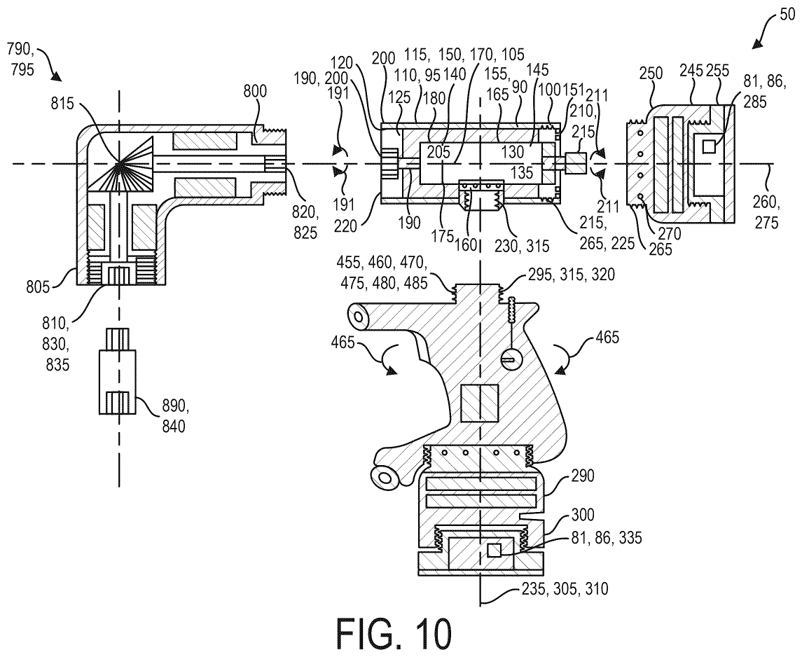

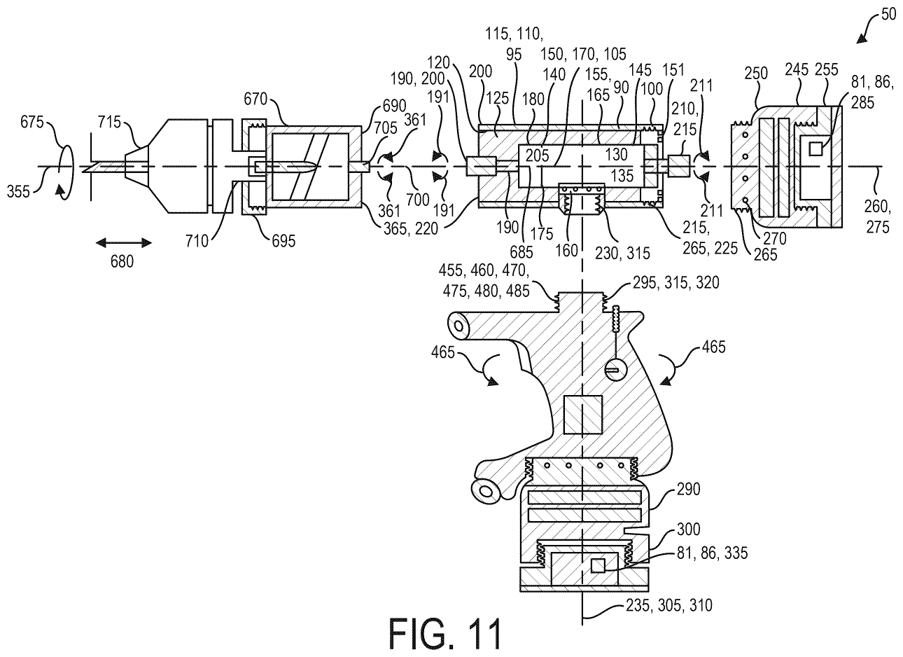

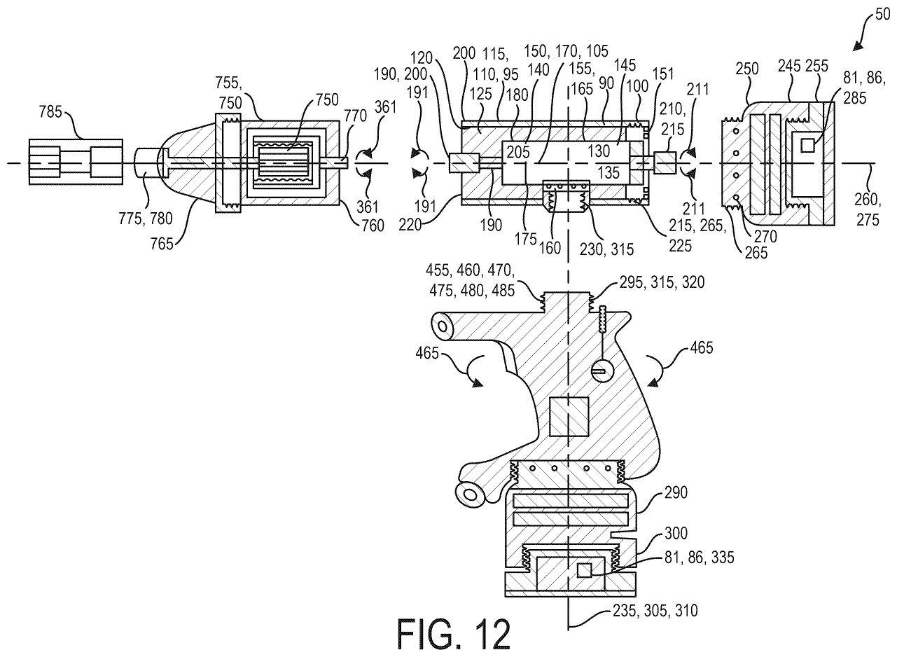

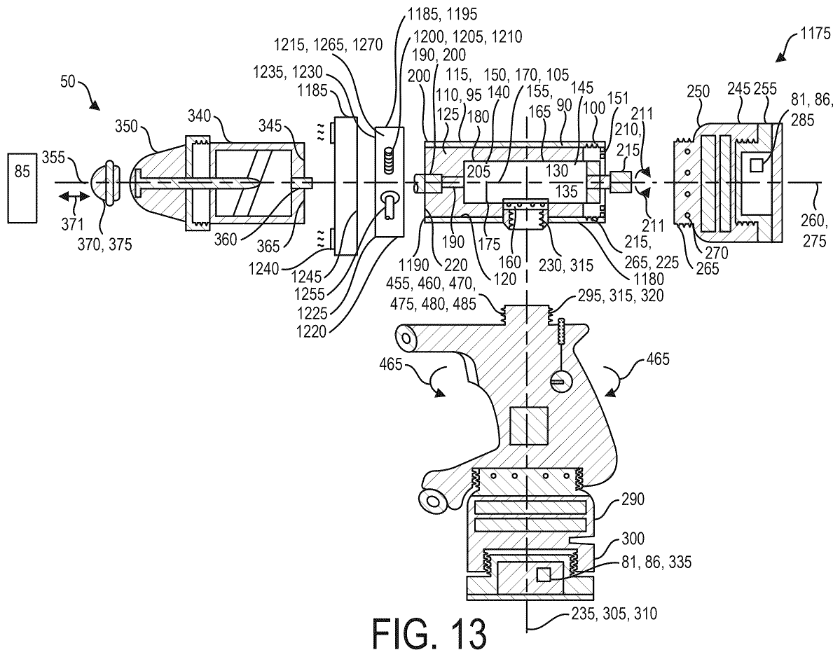

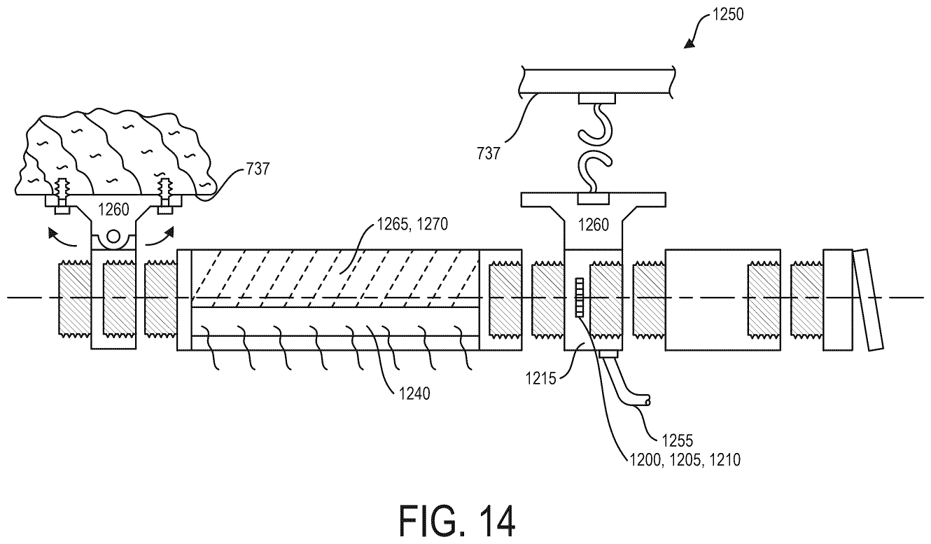

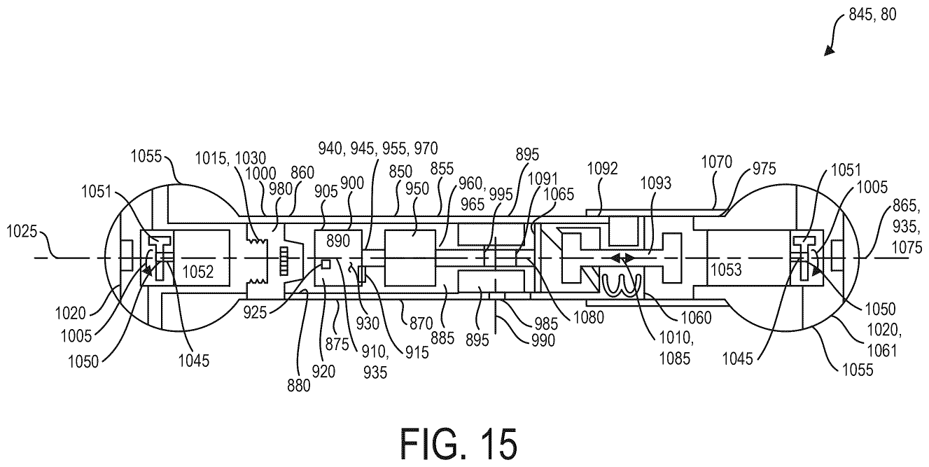

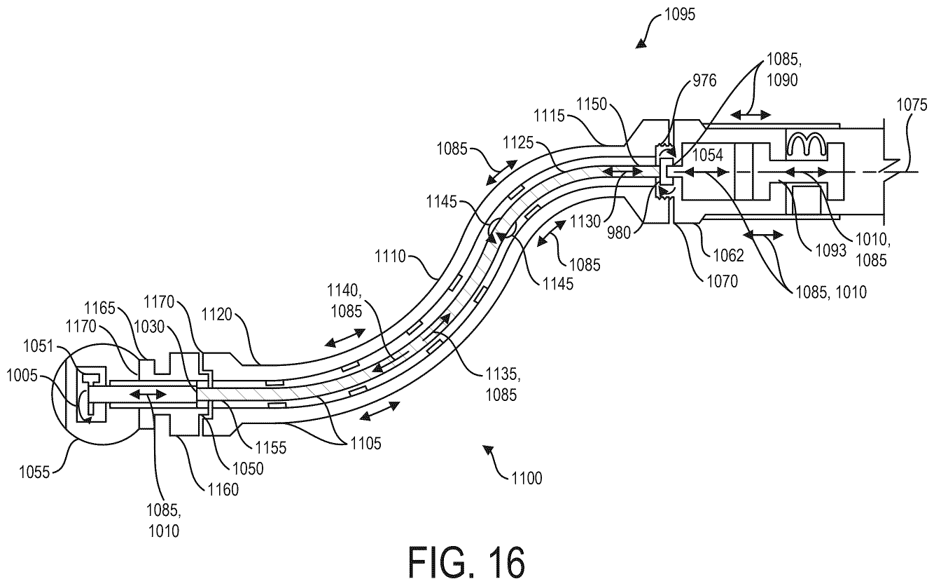

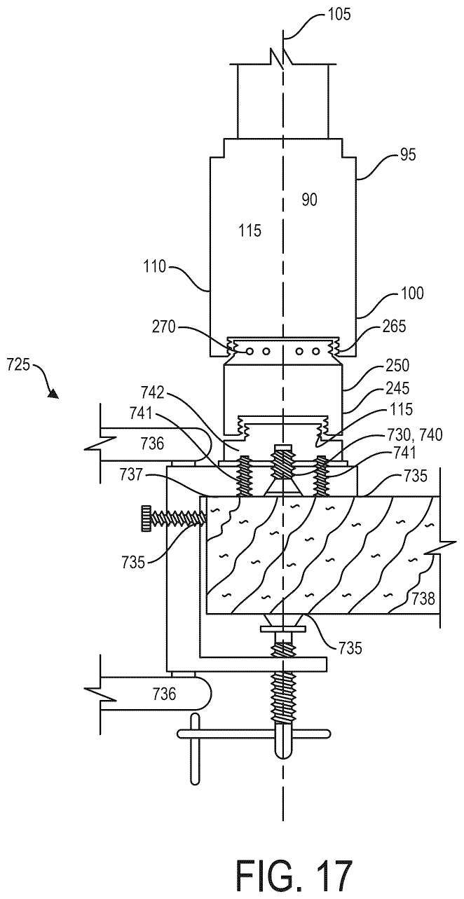

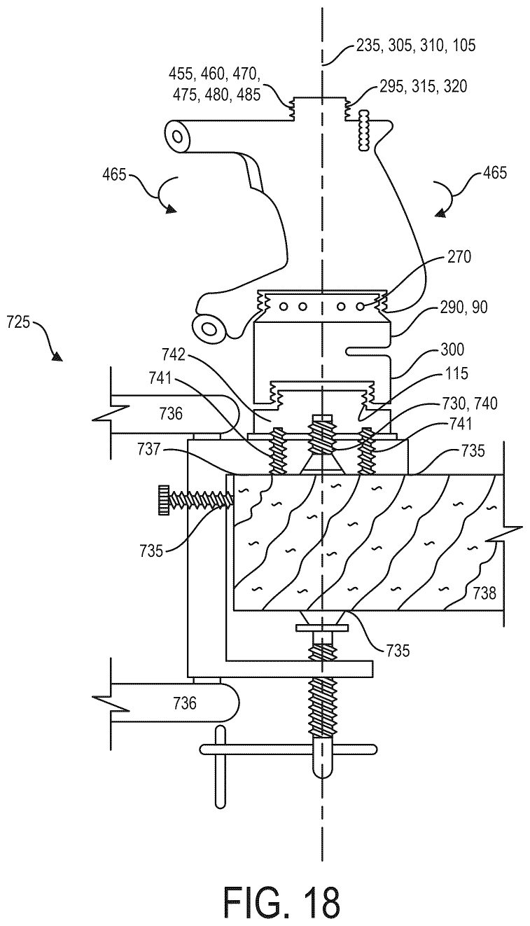

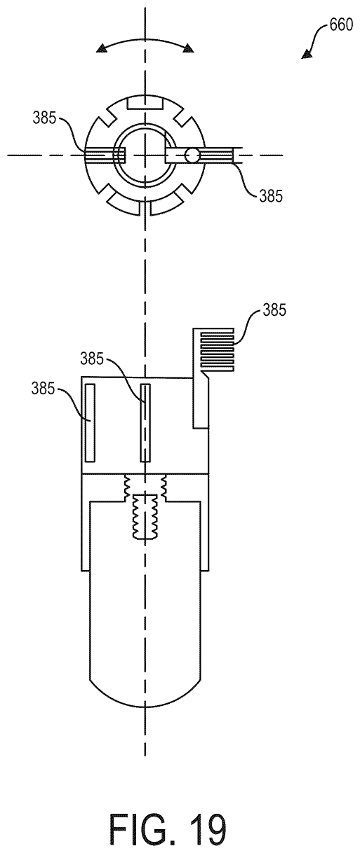

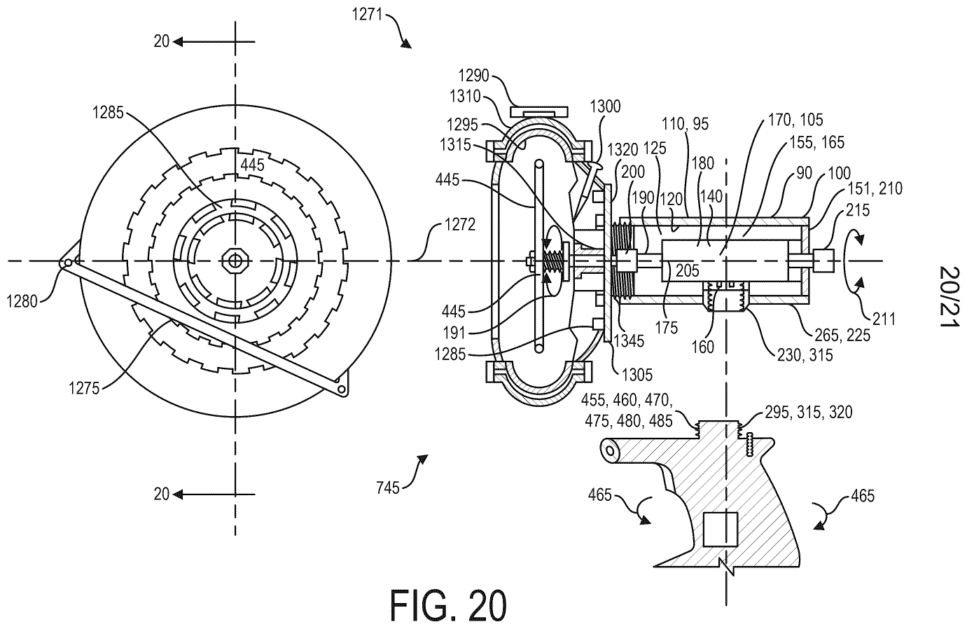

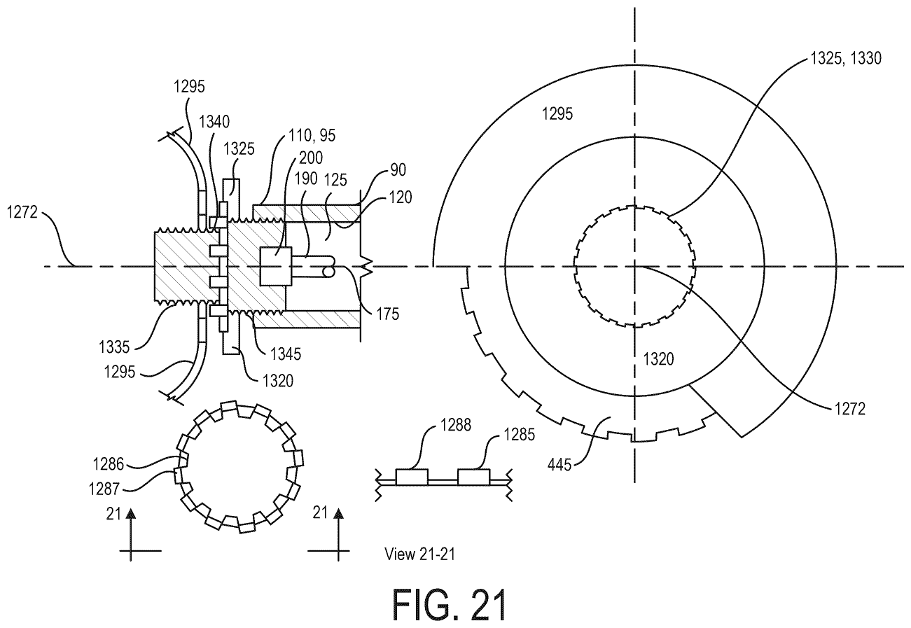

50 A self-contained modular rotary/reciprocal/vibratory movement multi-purpose tool apparatus
55 Cutting
60 Drilling
65 Trimming
70 Sanding
75 Polishing
80 Massaging
81 Plurality of tool pieces
85 Article
86 Tool pieces
90 Core first module
95 First end portion of the core first module 90
100 Second end portion of the core first module 90
105 Longitudinal axis of the core first module 90
110 Surrounding sidewall of the core first module 90
115 Outer surface of the surrounding sidewall 110 of the core first module 90
120 Inner surface of the surrounding sidewall 110 of the core first module 90
125 Interior of the core first module 90
130 Motor of the core first module 90
135 Energy source of the motor 130
140 Primary end portion of the motor 130
145 Secondary end portion of the motor 130
150 Rotational axis of the motor 130
151 First plurality of removably engageable electrical communications of the secondary end portion 145
155 Body portion of the motor 130
160 Second plurality of removably engageable electrical communications of the motor 130 body portion 155
165 External portion of the motor 130 body portion 155
170 Co-incident positioning of the core longitudinal axis 105 and the motor 130 rotational axis 150
175 Primary motor 130 output shaft
176 Bi-directional rotation of the primary motor 130 output shaft 175
180 Rotational speed reduction transmission
185 Input shaft of the rotational speed reduction transmission 180
186 Bi-directional rotation of the input shaft 185 of the rotational speed reduction transmission 180
190 Output shaft of the rotational speed reduction transmission 180
191 Bi-directional rotation of the output shaft 190 of the rotational speed reduction transmission 180
195 Rotational engagement as between the primary motor 130 output shaft 175 and the rotational speed reduction transmission 180 input shaft 185
200 First means that is preferably a square head internal drive for rotational removable engagement at the output shaft 190 being disposed at the core 90 first end portion 95
205 Rotational speed reduction transmission 180 disposed within the core 90 first end portion 95
210 Motor 130 direct drive output shaft disposed at the motor 130 secondary end portion 145
211 Bi-directional rotation of the motor 130 direct drive output shaft 210 disposed at the motor 130 secondary end portion 145
215 Second means that is preferably a square head internal drive for rotational removable engagement at the output shaft 210 being disposed at the core 90 second end portion 100
220 Third means being preferably internal/external threads for removable engagement at the core 90 first end portion 95
225 Fourth means being preferably internal/external threads for removable engagement at the core 90 second end portion 100
230 First interface of the core 90 surrounding sidewall 110 that is disposed therethrough the core 90 surrounding sidewall 110 outer surface 115 to the core 90 surrounding sidewall 110 inner surface 120
235 First extension axis of the first interface 230
240 Perpendicular position of the first extension axis 235 to the longitudinal axis 105
245 First auxiliary power second module
250 Prime end portion of the first auxiliary power second module 245
255 Accessory end portion of the first auxiliary power second module 245
260 Longwise axis of the first auxiliary power second module 245
265 Removable engagement of the prime end portion 250 that interfaces with the fourth means 225
270 First auxiliary electrical communication structure disposed on the prime end portion
250 that is removably engageable to the first plurality 151 of removably engageable electrical communications
275 Co-incident positioning of the core longitudinal axis 105 and the longwise axis 260
280 First assembled state of the first auxiliary power second module 245 and the core first module 90
285 First auxiliary container structure disposed on the accessory end portion 255 to store tool pieces 86
290 Second auxiliary power third module that can be a motor 130 energy source 135
295 Principal end portion of the second auxiliary power third module 290
300 Peripheral end portion of the second auxiliary power third module 290
305 Arm axis of the disposed as between the principal end portion 295 and the peripheral end portion 300
310 Co-incident positioning of the first extension axis 235 and the arm axis 305
315 Removable engagement of the principal end portion 295 and the first interface 230
320 Second auxiliary electrical communication structure that is removably engageable to the second plurality removably engageable electrical communications 160
325 Perpendicular position of the first extension axis 235 and arm axis 305 to the longitudinal axis 105
330 Second assembled state of the second auxiliary power third module 290 and the core first module 90
335 Second auxiliary container structure disposed on the peripheral end portion 295 to store tool pieces 86
340 Rotary rotation to variable reciprocal movement fourth module structure
345 Input end portion of the fourth module structure 340
350 Output end portion of the fourth module structure 340
355 Rotary/reciprocal axis of the fourth module structure 340 disposed therebetween the input end 345 and the output end 350 and the sixth module structure 670 therebetween the input end portion 690 and the output end portion 695
360 Input shaft of the fourth module structure 340 that is rotationally removably engageable to the first means for rotational engagement 200
361 Bi-directional rotation of the input shaft 360 of the fourth module structure 340 that is rotationally removably engageable to the first means for rotational engagement 200, also bi-directional rotation of the input shaft 360 of the sixth module structure 670 and the seventh module structure 755
365 Removable engagement of the input end portion 345 to the third means 220
370 Reciprocating output shaft of the fourth module structure 340
371 Reciprocating movement of the reciprocating output shaft 370 of the fourth module structure 340
375 Fifth means preferably an internal/external thread for reciprocating removable engagement of the reciprocating output shaft 370
380 Reciprocating tool that is removably engaged to the fifth means 375
385 Reciprocating tool that can be but not limited to a reciprocating saw, a hex bit, a T-slot saw, a needle file, a grill brush, a grill gate scrapper, a chisel, a scrapping blade, a rasp, a drywall file, a razor, a nail file, an emery board, a linear sander, a linear abrasive mesh pad, a sharpening stone, a lock pick, a cheese grater, a meat tenderizer, a needler, a scrapping blade, an ice scrapper, a decal eraser, a jig saw, and burnisher.
390 Rotary spindle fifth module
395 Input end portion of the rotary spindle fifth module 390
400 Output end portion of the rotary spindle fifth module 390
405 Rotary spindle axis of the rotary spindle fifth module 390
410 Input shaft of the rotary spindle fifth module 390
415 Removable engagement of the input shaft 410 to the first means 200
420 Removable engagement of the input end portion 395 to the third means 220
425 Output shaft of the rotary spindle fifth module 390 output end portion 400 that projects from the disc 430
430 Disc of the of the output end portion 400
435 Perpendicular orientation of the disc 430 to the output shaft 425 and rotary spindle axis 405
440 Sixth means being preferably external threads and radial support plate 450 for rotational and radial removable engagement
441 Bi-directional rotation of the sixth means 440 for rotational and radial removable engagement
445 Rotary spindle tool that can be but not limited to a circular saw, an angle grinder, an air blower, a needle file, a chain saw, a belt sander, an angle sander, a coffee grinder, a pump, a weed eater, a wire brush, and a torque driver.
450 Support plate removable engagement of the rotary spindle tool 445 to the sixth means 440
455 Rotary couple
460 First rotational lock
465 Rotation about the arm axis 305 of the principal end portion 295 and the peripheral end portion 300 of the one-hundred eighty-degree rotation
470 Second rotational lock
475 Slip ring architecture
480 Plurality of third auxiliary electrical communications from the slip ring architecture
475 as between the principal end portion 295 and the core surrounding sidewall outside surface 115 at the first interface 230 to allow electrical communication from the first rotational lock of the one-hundred eighty degree rotation to the second rotational lock and vice versa
485 Ultimately providing electrical power from the second auxiliary power third module
290 to the motor 130 via the plurality of third auxiliary electrical communications 480 during the one-hundred eighty degree rotation from the first rotational lock to the second rotational lock and vice versa
600 Chuck rotational holding vise, see FIG. 8
605 A plurality of rotating tools (not shown) that are ultimately removably engaged to the first means for rotational engagement 200 via the chuck rotational holding vise 600 for rotational removable engagement that is selected from the group consisting of a drill bits, paddle/flat wood drills, a rotating snow brush, and a hole saw.
610 Plurality of the first auxiliary electrical communication structures 270, see FIG. 6
615 Stacked and nested manner of the plurality 610 of the first auxiliary electrical communication structures 270, see FIG. 6
620 Removably engageable parallel electrical communication of each of the plurality 610 of the first auxiliary electrical communication structures 270 to one another, see FIG. 6
625 The first auxiliary electrical communication structure 270 is sized and configured to accommodate a plurality 610 of the first auxiliary electrical communication structures 270 in a stacked and nested manner 615 that are electrically removably connected 620 to one another in electrically parallel electrical communication to further increase the motor 130 run time, see FIG. 6
630 Standardized electrical power sources from existing manufacturers, see FIG. 7
635 The second auxiliary electrical communication structure 320 that is removably engageable to the first auxiliary electrical communication structures 270 is sized and configured to accommodate standardized electrical power sources from existing manufacturers 630, see FIG. 7
640 Surrounding sidewall safety shroud, see FIG. 9
645 Removable engagement of the surrounding sidewall safety shroud 640, see FIG. 9
650 Fourth module output end portion
655 A sixteenth means being preferably a male/female threaded interface for the fourth module output end portion 650 removable engagement with the surrounding sidewall safety shroud
640 about the rotary/reciprocal axis 355, see FIG. 9
660 Multiple reciprocating tool 385 receptacle carriage for the variable reciprocal movement fourth module that manually indexes one reciprocating tool at a time for use, see FIG. 19.
665 Rotary rotation to variable reciprocal movement fourth module 340 further includes a surrounding sidewall safety shroud 640 to protect external egress into the reciprocating output shaft 370, the safety shroud 640 is removably engaged 645 to the fourth module 340 output end portion
650 sixteenth means 655, the rotary rotation to variable reciprocal movement fourth module 340 further includes the multiple reciprocating tool 385 receptacle carriage 660 that manually indexes one reciprocating tool 385 at a time for use, see FIG. 9.
670 Sixth module that is a rotary rotation to hammer drill movement combining drill rotation 675 with rapid axial back and forth movement 680 along the motor rotational axis 685 defined as a sixth module 670 that includes a sixth module input end portion 690 and an opposing sixth module output end portion 695 with a rotary/hammer movement axis 700 disposed therebetween, further the rotary rotation to hammer movement sixth module 670 has an input shaft 705 that is rotationally removably engageable to the first means for rotational engagement 200, the sixth module input end portion 690 is removably engaged to the third means for removable engagement 220, further the rotary rotation to hammer movement sixth module 670 has a hammer drill output shaft 710 that has a seventh means 715 for the hammer drill removable engagement, wherein operationally the hammer drill 670 utilizes tools that include masonry drill bits and drain cleaning snakes, see FIG. 11.
675 Drill rotation movement of the hammer drill 670, see FIG. 11
680 Rapid axial back and forth movement of the hammer drill 670, see FIG. 11
685 Motor rotational axis, see FIG. 11
690 Input end portion of the sixth module 670, see FIG. 11
695 Output end portion of the sixth module 670, see FIG. 11
700 Rotary/hammer movement axis, see FIG. 11
705 Input shaft of the sixth module 670, see FIG. 11
710 Hammer drill output shaft, see FIG. 11
715 Seventh means being preferably a rotational chuck vise with axial tool 720 stop for the sixth module 670 hammer drill removable engagement, see FIG. 11
720 Sixth module 670 hammer drill that utilizes tools that include masonry drill bits and drain cleaning snakes, see FIG. 11
725 Bench mount for the core first module 90 that has the core first end portion 95 and the opposing core second end portion 100 with the core longitudinal axis 105 spanning therebetween, the core first module 90 also includes the core surrounding sidewall 110 with the core surrounding sidewall outer surface 115 and the opposing core surrounding sidewall inner surface 120, the bench mount 725 is removably engaged 730 to an adapter 742 and then alternatively can attach to the first auxiliary power second module 245 or second auxiliary power third module 290 and then to the core surrounding sidewall inner surface 120 or directly to the core surrounding sidewall inner surface 120, and is adaptable to being affixed with structure 735 to a workbench vise 736 or a work bench surface 737 itself, the bench mount 725 has a structure for a multi-axis fixedly adjustable 740 to accommodate any X, Y, or Z axis position of the core longitudinal axis 105 in relation to the affixed structure 735 for the benchtop vise 736 or work surface 737, this is to operationally allow for hands free use of the multipurpose tool 50 in that the multipurpose tool 50 does not need to be hand held by a user, wherein the user can use both of their hands to hold their article 85 that is being worked on with the multipurpose tool 50l, see FIGS. 17 and 18
730 Removably engagement of the bench mount 725 to the core surrounding sidewall outer surface 115, see FIG. 18
735 Affixed structure of the bench mount 725 to a work bench vise 736 or work bench surface 737, see FIGS. 17 and 18
736 Work bench vise, see FIGS. 17 and 18
737 Work bench surface, see FIGS. 17 and 18
738 Work bench, see FIGS. 17 and 18
740 Multi-axis fixedly adjustable structure of the bench mount 725, see FIGS. 17 and 18
741 Rotational lock for the multi-axis fixedly adjustable structure 740, see FIGS. 17 and 18
742 Adapter for the bench mount 725, see FIGS. 17 and 18
745 Rotationally lockable removably engageable annular safety shroud for a disc 400 type rotary spindle tool 445 on the rotary spindle fifth module 390, see FIG. 20
750 Rotational torque control that can be continuous torque control or intermittent rotational torque variance as in the manner of an ordinary skill in the art impact wrench in a seventh module 755 that includes a seventh module 755 input end portion 760 and an opposing seventh module 755 output end portion 765 with the rotational continuous or intermittent torque control 750 disposed therebetween, further the rotational continuous or intermittent torque control 750 seventh module 755 has an input shaft 770 that is rotationally removably engageable to the first means for rotational engagement 200, the seventh module 755 input end portion 760 is removably engaged to the third means 220 for removable engagement, further the rotational continuous or intermittent torque control 750 seventh module 755 has an output shaft 775 that has a eighth means 780 for continuous or intermittent torque control 750 removable engagement, wherein operationally the rotational continuous or intermittent torque control 750 utilizes tools 785 to be removably engaged to the eighth means 780 that include sockets, ratchets, and wrenches, see FIG. 12.
755 Seventh module, see FIG. 12
760 Input end portion of the seventh module 755, see FIG. 12
765 Output end portion of the seventh module 755, see FIG. 12
770 Input shaft of the seventh module 755, see FIG. 12
775 Output shaft of the seventh module 755, see FIG. 12
780 Eighth means being preferably a square drive head for continuous or intermittent torque control 750 removable engagement, see FIG. 12
785 Tools removably engaged to the eighth means 780 that include sockets, ratchets, and wrenches, see FIG. 12
790 Right angle rotational drive that includes a pair of mated/meshed beveled gears with rotational torque control in an eighth module 795 that includes a eighth module input end portion
800 and an opposing eighth module output end portion 805 with a right angle rotational drive 810 with rotational torque control 815 disposed therebetween, further the right angle rotational drive
810 with rotational torque control 815 eighth module 795 has an input shaft 820 that is rotationally removably engageable 825 to the first means for rotational engagement 200, the eighth module 795 input end portion 800 is removably engaged to the third means for removable engagement 220, further the right angle rotational drive 810 with rotational torque control 815 eighth module 795 has an output shaft 830 that has a nineth means for torque control removable engagement 835, wherein operationally the right angle rotational drive 810 with rotational torque control 815 utilizes tools 840 to be removably engaged to the ninth means 835 that include sockets, ratchets, angle grinders, abrasive wheels, chain saw, and wrenches, see FIG. 10
795 Eighth module, see FIG. 10
800 Input end portion of the eighth module 795, see FIG. 10
805 Output end portion of the eighth module 795, see FIG. 10
810 Right angle rotational drive, see FIG. 10
815 Rotational torque control for the right angle rotational drive 810, see FIG. 10
820 Input shaft pf the eighth module 795, see FIG. 10
825 Rotational removable engagement of the input shaft 820 to the first means for rotational engagement 200, see FIG. 10
830 Output shaft that has a nineth means for torque control removable engagement 835, see FIG. 10
835 Nineth means being preferably a male/female hex drive for torque control removable engagement, see FIG. 10
840 Tools for the right angle rotational drive 810 that can be but not limited to utilizing tools to be removably engaged to the ninth means 835 that include sockets, ratchets, angle grinders, abrasive wheels, chain saw, and wrenches, see FIG. 10
845 A self-contained modular rotary/reciprocal/vibratory movement first alternative embodiment of the multi-purpose tool apparatus 845, the multi-purpose tool apparatus 845 is for cutting 55, drilling 60, trimming 65, sanding 70, polishing 75, or massaging 80 utilizing a plurality of tool pieces 81 for work upon an article 85, see FIG. 15
850 Core second module that has a core first end portion 855 and an opposing core second end portion 860 with a core percussion axis 865 spanning therebetween, the core second module 850 also includes a core surrounding sidewall 870 with a core surrounding sidewall outer surface 875 and an opposing core surrounding sidewall inner surface 880 the core module further includes a core second module interior 885 that is defined by the core second module surrounding sidewall inner surface 880 and the first 855 and second 860 core end portions, the core second module further includes a motor 890 with an energy source 895 that is disposed within the core second module interior 885, the motor 890 has a motor primary end portion 900 and an opposing motor secondary end portion 905 with a motor rotational axis 910 disposed therebetween, wherein the motor secondary end portion 905 further includes a first plurality of removably engageable electrical communications 915 wherein the motor further has a body portion 920 that is disposed between the motor primary end portion 900 and the motor secondary end portion 905. The motor body portion 920 further includes a second plurality of removably engageable electrical communications 925 that are disposed upon an external portion 930 of the motor body portion 920 wherein the core percussion axis 865 and the motor rotational axis 910 are substantially coincident 935 to one another, the motor primary end portion 900 further includes a primary motor output shaft 940 that is rotationally engaged 945 to a speed reduction transmission 950 through a speed reduction transmission input shaft 955, wherein the speed reduction transmission 950 has a speed reduction transmission output shaft 960 that has a tenth means 965 for rotational removable engagement disposed at the core first end portion 855 the speed reduction transmission 950 is disposed within the core first end portion 855. The core first end portion 855 has a twelfth means 975 for removable engagement and the core second end portion 860 has a thirteenth means 980 for removable engagement, the core surrounding sidewall 870 further includes a second interface 985 that is disposed therethrough from said core surrounding sidewall 870 outer surface 875 to the core surrounding sidewall 870 inner surface 880, said second interface 985 is about a second extension axis 990 that is positioned substantially perpendicular 995 to the percussion axis 865, see FIGS. 15 and 16
855 First end portion for the core second module 850, see FIGS. 15 and 16
860 Second end portion for the core second module 850, see FIGS. 15 and 16
865 Core percussion axis for the core second module 850, see FIGS. 15 and 16
870 Core surrounding sidewall for the core second module 850, see FIGS. 15 and 16
875 Outer surface of the core surrounding sidewall 870, see FIGS. 15 and 16
880 Inner surface of the core surrounding sidewall 870, see FIGS. 15 and 16
885 Core second module interior that is defined by the core second module surrounding sidewall inner surface 880 and the first 855 and second 860 core end portions, see FIGS. 15 and 16
890 Motor for the core second module 850, see FIGS. 15 and 16
895 Energy source that is disposed within the core second module interior 885, see FIGS. 15 and 16
900 Primary end portion of the motor 890, see FIGS. 15 and 16
905 Secondary end portion of the motor 890, see FIGS. 15 and 16
910 Rotational axis of the motor 890, see FIGS. 15 and 16
915 First plurality of removably engageable electrical communications that are disposed on the motor secondary end portion 905, see FIGS. 15 and 16
920 Body portion of the motor 890, see FIGS. 15 and 16
925 Second plurality of removably engageable electrical communications that are disposed upon an external portion 930 of the motor body portion 920, see FIGS. 15 and 16
930 External portion of the motor body portion 920, see FIGS. 15 and 16
935 Substantially coincident position of the core percussion axis 865 and the motor rotational axis 910, see FIGS. 15 and 16
940 Primary motor output shaft for the motor 890, see FIGS. 15 and 16
945 Rotationally engaged interface of the primary motor output shaft 940 to the speed reduction transmission 950 through a speed reduction transmission input shaft 955, see FIGS. 15 and 16
950 Speed reduction transmission, see FIGS. 15 and 16
955 Input shaft of the speed reduction transmission 950, see FIGS. 15 and 16
960 Output shaft of the speed reduction transmission 950, see FIGS. 15 and 16
965 Tenth means being preferably a male/female hex drive for rotational removable engagement disposed at the core first end portion 855, see FIGS. 15 and 16
970 Eleventh means being preferably a male/female hex drive for rotational removable engagement disposed at the core second end portion 860, see FIGS. 15 and 16
975 Twelfth means being preferably a male/female threaded engagement for removable engagement, see FIGS. 15 and 16
976 Twentieth means being preferably a male/female threaded interface for removable engagement, see FIGS. 15 and 16
980 Thirteenth means being preferably a male/female threaded engagement for removable engagement, see FIGS. 15 and 16
985 Second interface that is disposed therethrough from the core surrounding sidewall 870 outer surface 875 to the core surrounding sidewall 870 inner surface 880, see FIGS. 15 and 16
990 Second extension axis that is positioned substantially perpendicular 995 to the percussion axis 865, see FIGS. 15 and 16
995 Substantially perpendicular position of the second extension axis 990 to the percussion axis 865, see FIGS. 15 and 16
1000 Ninth module that is a rotary rotation to variable imbalance rotary 1005 percussive movement 1010 that includes a nineth module 1000 input end portion 1015 and an opposing nineth module 1000 output end portion 1020 with a variable percussive axis 1025 disposed therebetween, further the nineth module 1000 input end portion 1015 includes a fifteenth means 1030 for removable engagement, further the variable rotary 1005 percussive movement 1010 ninth module 1000 has a variable rotary 1005 percussive 1010 movement output shaft 1045 that has a fourteenth means 1050 for variable rotary movement 1010 via a first motor drive 1052 with an imbalance element 1051 and percussive 1010 movement removable engagement, the rotary rotation 1005 to variable rotary percussive movement 1010 nineth module 1000 further includes a soft tip dome 1055 shaped massager extension that is removably engaged to the fifteenth means 1030 to operationally provide massage movement with rotary 1005 variable imbalance and percussion movement 1010, see FIGS. 15 and 16
1005 Rotary movement, see FIGS. 15 and 16
1010 Percussive or reciprocal movement, see FIGS. 15 and 16
1015 Input end portion of the ninth module 1000, see FIGS. 15 and 16
1020 Output end portion of the nineth module 1000 or tenth module 1060, see FIGS. 15 and 16
1025 Variable percussive axis, see FIGS. 15 and 16
1030 Fifteenth means being preferably a male/female threaded engagement for the removable engagement of the output end portion 1020 of the nineth module 1000, see FIGS. 15 and 16
1045 Output shaft of the ninth module 1000, see FIGS. 15 and 16
1050 Fourteenth means being preferably a press fit removable engagement, see FIGS. 15 and 16
1051 Rotary imbalance element, see FIGS. 15 and 16
1052 First motor drive with the imbalance element 1051, see FIGS. 15 and 16
1053 Second motor drive with the imbalance element 1051, see FIGS. 15 and 16
1054 Third motor drive with the imbalance element 1051, see FIG. 16
1055 Soft tip dome shaped massager extension that is removably engaged to the fifteenth means 1030 to operationally provide massage movement with rotary 1010 variable imbalance percussion 1005, see FIG. 15
1060 Tenth module for the rotary rotation 1005 to variable imbalance rotary percussive movement 1010, the variable reciprocal movement 1085 tenth module 1060 for the rotary rotation 1005 to variable imbalance rotary percussive movement 1010, that includes a tenth module 1060 input end portion 1065 and an opposing tenth module output end portion 1070 with a variable reciprocal axis 1075 disposed therebetween, including a reciprocating mass 1093 with reciprocating movement 1085 along the variable reciprocating axis further the tenth module output end portion 1070 includes a twelfth means 975 for removable engagement, further the variable reciprocal movement 1010 tenth module 1060 has an input shaft 1080 that is rotationally removably engageable to the eighteenth means 1091 for variable rotary percussive movement 1085 removable engagement rotational engagement, the tenth module 1060 input end portion 1065 is removably engaged to the nineteenth means 1092 for removable engagement, further the variable reciprocal movement 1085 tenth module 1060 variable reciprocating output with rotary variable imbalance percussion output shaft 1090, see FIGS. 15 and 16.
1061 The eleventh module, further the variable rotary 1010 percussive movement 1005 has a variable rotary 1010 percussive 1005 movement output shaft 1045 that has a fourteenth means 1050 for variable rotary movement 1010 via a second motor drive 1053 with an imbalance element 1051 and percussive 1005 movement removable engagement, the rotary rotation 1010 to variable rotary percussive movement 1005 eleventh module 1061 further includes a soft tip dome 1055 shaped massager extension that is removably engaged to the twelfth means 975 to operationally provide massage movement with rotary 1010 variable imbalance and percussion movement 1005, see FIG. 15
1062 Alternate version of the tenth module 1060 that is sized and configured to interface with the wand 1100 at the twentieth means 976 for removable engagement, see FIG. 16
1065 Input end portion of the tenth module 1060, see FIG. 15
1070 Output end portion of the tenth module 1060, see FIGS. 15 and 16
1075 Variable reciprocal axis, see FIGS. 15 and 16
1080 Input shaft of the tenth module 1060, see FIGS. 15 and 16
1085 Variable rotary reciprocal movement that translates into a variable rotary percussive movement, see FIGS. 15 and 16
1090 Output shaft for the alternate version 1062 of the tenth module 1060 via the third motor 1054, see FIG. 16
1091 Eighteenth means being preferably a press fit removable engagement, see FIG. 15
1092 Nineteenth means being preferably a male/female threaded engagement for removable engagement, see FIG. 15
1093 Reciprocating mass of the tenth module 1060 or the alternate version 1062 of the tenth module 1060, see FIGS. 15 and 16
1095 Replacing the soft tip dome shaped massager extension 1055 with a wand 1100 that includes a Bowden cable 1105 that structurally is defined as a flexible tube 1110 that is affixed at each end defined as a flexible tube proximal end portion 1115 and an opposing flexible tube distal end portion 1120, wherein disposed within the flexible tube 1110 is a loose fitting fine wire rope 1125 that has the ability to slide 1130 within the flexible tube 1110, thus having the ability to be directly transmitting, pulling 1135, pushing 1140, and turning 1145 movements, the fine wire rope 1125 having a fine wire rope proximal end portion 1150 and an opposing fine wire rope distal end portion 1155. The flexible tube proximal end portion 1115 is removably engaged to the alternate version 1062 of the tenth module 1060 output end portion 1070 via the twentieth means 976 for removable engagement and the fine wire rope 1125 proximal end portion 1150 is removably engaged to the alternate version 1062 of the tenth module 1060 variable reciprocating output with rotary variable imbalance percussion 1085 output shaft 1090 that has via the thirteenth means 980 for removable engagement, the flexible tube distal end portion 1120 has a fourteenth means 1050 for removable engagement and the fine wire rope distal end portion 1155 has a fifteenth means 1030 for removable engagement, the wand 1100 further includes a soft tip dome shaped massager extension 1055 having a housing 1160 that is being partially disposed about a soft tip dome shaped massager 1055 base 1165. Wherein the soft tip dome shaped massager 1055 base 1165 is removably engaged 1170 to the fourteenth means 1050 for removable engagement, and the soft tip dome shaped massager 1055 is removably engaged to the fifteenth means 1030 to operationally provide massage movement with variable reciprocating output 1085 with rotary variable imbalance percussion movement 1085 at the distal end portion 1120 of the flexible tube 1110 and the distal end portion 1155 of the fine wire rope 1125 at the soft tipped dome shaped massager 1055 forming the wand 1100 that allows remote massage from the alternate version 1062 of the tenth module 1060, see FIG. 16
1100 Wand, see FIG. 16
1105 Bowden cable, see FIG. 16
1110 Flexible tube, see FIG. 16
1115 Proximal end portion of the flexible tube 1110, see FIG. 16
1120 Distal end portion of the flexible tube 1110, see FIG. 16
1125 Fine wire rope, see FIG. 16
1130 Ability to slide of the fine wire rope 1125 within the flexible tube 1110, see FIG. 16
1135 Pulling movement of the fine wire rope 1125, see FIG. 16
1140 Pushing movement of the fine wire rope 1125, see FIG. 16
1145 Turning movement of the fine wire rope 1125, see FIG. 16
1150 Proximal end portion of the fine wire rope 1125, see FIG. 16
1155 Distal end portion of the fine wire rope 1125, see FIG. 16
1160 Housing of the soft tip dome shaped massager 1055, see FIG. 16
1165 Base of the soft tip dome shaped massager 1055, see FIG. 16
1170 Removable engagement of the base 1165 via the fourteenth means 1050, see FIG. 16
1175 A self-contained modular rotary/reciprocal/vibratory movement second alternative embodiment multi-purpose tool apparatus 1175, the multi-purpose tool apparatus 1175 is for cutting 55, drilling 60, trimming 65, sanding 70, polishing 75, or massaging 80 utilizing a plurality of tool pieces 81 for work upon an article 85, see FIGS. 13 and 14
1180 Core first module 90 that has the core first end portion 95 and the opposing core second end portion 100 with the core longitudinal axis 105 spanning therebetween, the core first module 90 also includes the core surrounding sidewall 110 with the core surrounding sidewall outer surface 115 and the opposing core surrounding sidewall inner surface 120, the core first module 90 further includes the core first module interior 125 that is defined by the core first module surrounding sidewall inner surface 120 and the first 95 and second 100 core end portions, the core first module 90 further includes a motor 130 with an energy source 135 that is disposed within the core first module interior 125, the energy source 135 further powers an electrical accessory 1185, the motor 130 has the motor primary end portion 140 and the opposing motor secondary end portion 145 with the motor rotational axis 150 disposed therebetween. Wherein the motor secondary end portion 145 further includes the first plurality of removably engageable electrical communications 151, wherein the motor 130 further has a body portion 155 that is disposed between the motor primary end portion 140 and the motor secondary end portion 145, the motor body portion 155 further includes the second plurality of removably engageable electrical communications 160 that are disposed upon an external portion 165 of the motor body portion 155. Wherein the core longitudinal axis 105 and the motor rotational axis 150 are substantially coincident 170 to one another, the motor primary end portion 140 further includes the primary motor output shaft 175 that is rotationally engaged 195 to the speed reduction transmission 180 through the speed reduction transmission input shaft 185, wherein the speed reduction transmission 180 has the speed reduction transmission output shaft 190 that has the first means 200 for rotational removable engagement disposed at the core 90 first end portion 95, the speed reduction transmission 180 is disposed 205 within the core first end portion 95, the motor secondary end portion 145 further includes the direct motor output shaft 210 having the second means 215 for rotational removable engagement disposed at the core second end portion 100, the core first end portion 95 has the third means 220 for removable engagement, the core first end portion 95 has a third plurality of electrical accessory removably engageable electrical communications 1190 that are disposed upon the third means 220, and the core second end portion 100 has the fourth means 225 for removable engagement. The core surrounding sidewall 110 further includes the first interface 230 that is disposed therethrough from the core surrounding sidewall outer surface 115 to the core surrounding sidewall inner surface 120, the first interface 230 is about the extension axis 235 that is positioned substantially perpendicular 240 to the core longitudinal axis 105, further operationally utilizing a plurality of rotating tools 605 that are removably engaged to the first means 200 via a chuck rotational holding vise 500 for rotational removable engagement that is selected from the group consisting of a drill bits, paddle/flat wood drills, a rotating snow brush, and a hole saw, see FIGS. 13 and 14.
1185 Electrical accessory, see FIGS. 13 and 14
1190 Third plurality of electrical accessory removably engageable electrical communications, see FIGS. 13 and 14
1195 Collar structure that functions as a switch 1200 that includes a light dimmer 1205 and power off/on switch 1210 that are tethered to one another via an electrical communication 1215, the collar structure 1195 has a proximal end portion 1220 and an opposing distal end portion 1225 wherein the collar structure 1195 proximal end portion 1220 interfaces with the third means 220 for removable engagement and the third plurality of electrical accessory removably engageable electrical communications 1190, further the collar structure 1195 distal end portion 1225 has a seventeenth means for removable engagement 1230 and a fourth plurality of electrical accessory removably engageable electrical communications 1235, see FIGS. 13 and 14
1200 Switch, see FIGS. 13 and 14
1205 Light dimmer, see FIGS. 13 and 14
1210 Power on/off switch, see FIGS. 13 and 14
1215 Electrical communication between the light dimmer 1205 and the power on/off switch, see FIGS. 13 and 14
1220 Proximal end portion of the collar structure 1195, see FIGS. 13 and 14
1225 Distal end portion of the collar structure 1195, see FIGS. 13 and 14
1230 Seventeenth means being preferably a magnetic interface for removable engagement, see FIGS. 13 and 14
1235 Fourth plurality of electrical accessory removably engageable electrical communications, see FIGS. 13 and 14
1240 Illumination element that is sized and configured to illuminate the article 85, the illumination element 1240 is removably engaged 1245 to said collar structure 1195 at the seventeenth means for removable engagement 1230 and at the fourth plurality of electrical accessory removably engageable electrical communications 1235, see FIGS. 13 and 14
1245 Removable engagement of the illumination element 1240 to the collar structure 1195, see FIGS. 13 and 14
1250 Illumination element 1240 that is sized and configured to remotely connect to the collar structure 1195 to be removably engaged to the collar structure 1195 at the seventeenth means
1230 for removable engagement and at the fourth plurality of electrical accessory removably engageable electrical communications 1235, further the illumination element 1240 utilizes an extension cord 1255 to have a removably engageable remote mount 1260 as between the illumination element 1240 and a surface 737, see FIGS. 13 and 14
1255 Extension cords, see FIGS. 13 and 14
1260 Removably engageable remote mount, see FIG. 14
1265 Illumination element 1240 is modified to include electronic accessories 1270 selected from the group consisting essentially of a gas detector, including flammable and toxic, motion detector, Bluetooth speaker, and Wifi hotspot, see FIG. 14
1270 Electronic accessories selected from the group consisting essentially of a gas detector, including flammable and toxic, motion detector, Bluetooth speaker, and Wifi hotspot, see FIG. 14.
1271 Guarded spindle twelfth module, see FIGS. 20 and 21
1272 Longitudinal axis of the guarded spindle twelfth module 1271, see FIGS. 20 and 21
1275 Circular saw platen, see FIGS. 20 and 21
1280 Platen support stop, see FIGS. 20 and 21
1285 Dual sided castellated rotation locking ring that operationally provides for variable locked rotational positions for the guarded spindle twelfth module 1271, see FIGS. 20 and 21
1286 Inner portion of the dual sided castellated rotation locking ring, see FIGS. 20 and 21
1287 Outer portion of the dual sided castellated rotation locking ring, see FIGS. 20 and 21
1288 Lower portion of the dual sided castellated rotation locking ring, see FIGS. 20 and 21
1290 Inner guard rotation lock, see FIGS. 20 and 21
1295 Inner rigid guard rotates within to ninety degrees rotation, see FIGS. 20 and 21
1300 Rotation lock for spindle 445, see FIGS. 20 and 21
1305 Rotational friction locking ring, see FIGS. 20 and 21
1310 Fold up of down platen guard, see FIGS. 20 and 21
1315 Sintered bushing, see FIGS. 20 and 21
1320 Inner backplate guard, see FIGS. 20 and 21
1325 Notches built into inner backplate guard 1320 that rotationally lock and engage with the outer portion of the dual sided castellated rotation locking ring 1287, see FIGS. 20 and 21
1330 Insert area of the dual sided castellated rotation locking ring 1285, see FIGS. 20 and 21
1335 Threads of the rotary spindle, see FIGS. 20 and 21
1340 Threaded engagement of the rotary spindle threads 1335 and the inner portion of the dual sided castellated rotation locking ring 1286, see FIGS. 20 and 21
1345 Male thread engagement to rotary drive core first module 90, see FIGS. 20 and 21

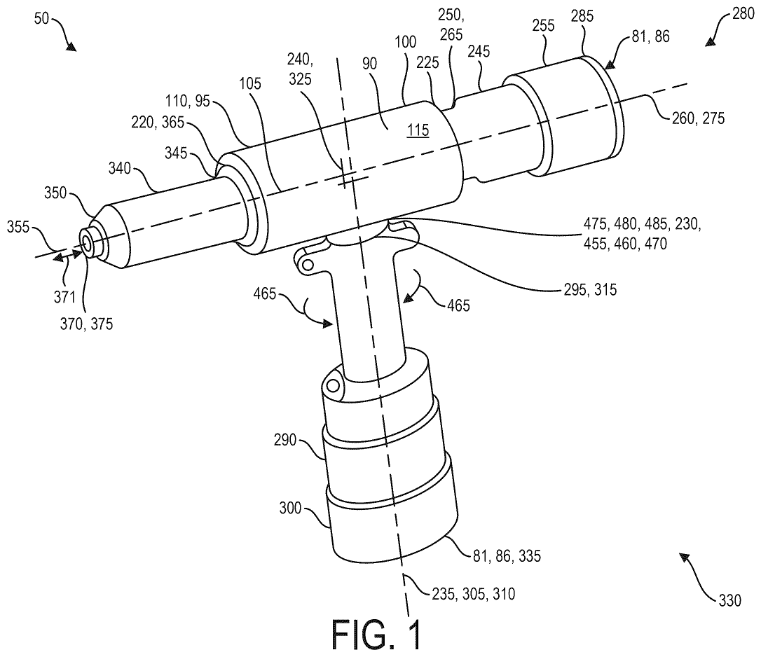

With initial reference to FIG. 1 shown is an upper perspective assembly view of the self-contained modular rotary/reciprocal/vibratory movement multi-purpose tool apparatus 50 that includes the core first module 90, plus the first auxiliary power second module 245 and its accessory end portion 255, the fourth module structure 340 and its output shaft 370, and further the second auxiliary power third module 290 and its peripheral end portion 300.

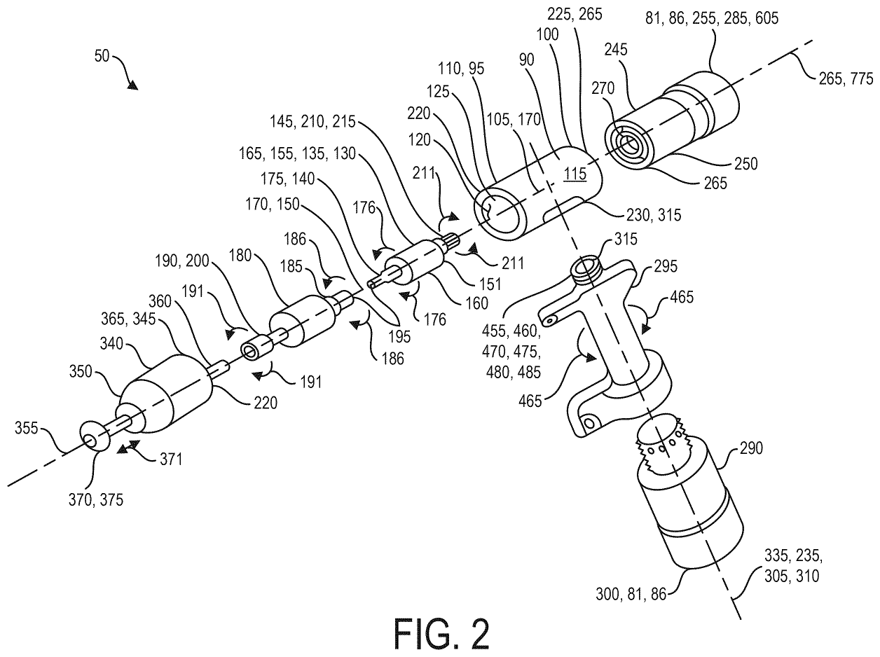

Next, FIG. 2 shows an exploded upper perspective dis-assembly view of the self-contained modular rotary/reciprocal/vibratory movement multi-purpose tool apparatus 50 that includes the core first module 90, plus the first auxiliary power second module 245 and its accessory end portion 255, the fourth module structure 340 and its output shaft 370, and further the second auxiliary power third module 290 and its peripheral end portion 300, in addition the motor 130 and the speed reduction transmission 180 are shown.

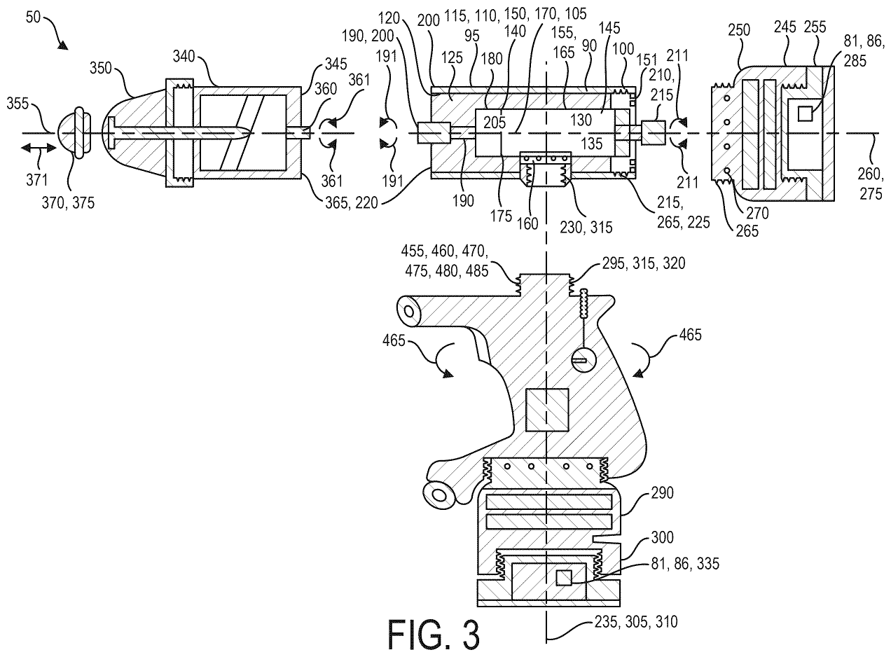

Further, FIG. 3 shows an exploded side elevation cross-section dis-assembly view of the self-contained modular rotary/reciprocal/vibratory movement multi-purpose tool apparatus 50 that includes the core first module 90, plus the first auxiliary power second module 245 and its accessory end portion 255, the fourth module structure 340 and its output shaft 370, and further the second auxiliary power third module 290 and its peripheral end portion 300, in addition the motor 130 and the speed reduction transmission 180, in addition to the rotary to reciprocal fourth module structure 340 are shown.

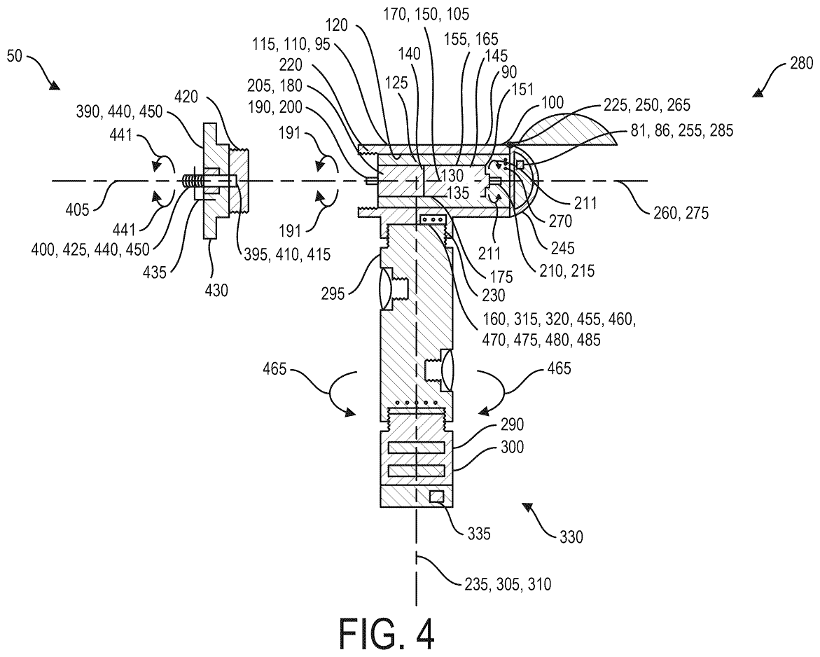

Continuing, FIG. 4 shows a partially exploded side elevation cross-section dis-assembly view of the self-contained modular rotary/reciprocal/vibratory movement multi-purpose tool apparatus 50 that includes the core first module 90, the first auxiliary container structure 285, the rotary spindle fifth module structure 390 and its output end portion 400, and further the second auxiliary power third module 290 and its peripheral end portion 300, in addition the motor 130 and the speed reduction transmission 180 are shown.

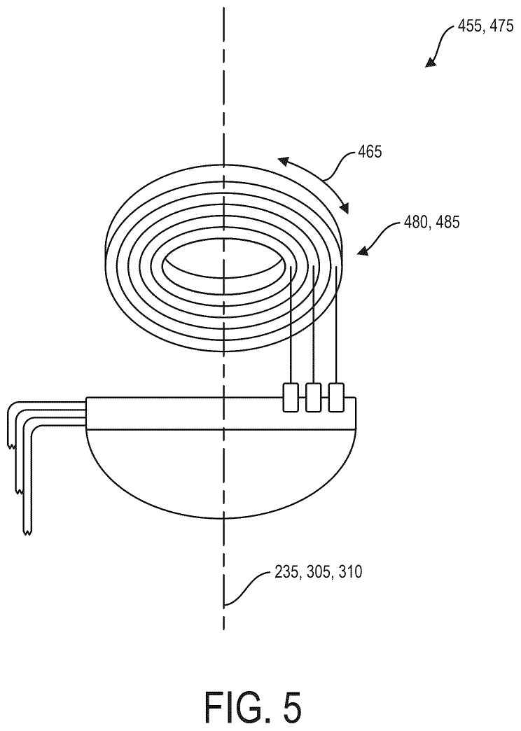

Moving onward, FIG. 5 shows an upper perspective view of the rotary couple 455 with slip ring architecture 475 for rotational electrical communication 480 at the second auxiliary power third module 290 at the first interface 230 to the core first module 90.

Further, FIG. 6 shows the exploded side elevation cross-section dis-assembly view of the self-contained modular rotary/reciprocal/vibratory movement multi-purpose tool apparatus 50 that includes the core first module 90, plus a plurality of the first auxiliary power second modules 245 electrically connected in parallel, and its accessory end portion 255, the fourth module structure 340 and its output shaft 370, and further a plurality of the second auxiliary power third modules 290 electrically connected in parallel, and its peripheral end portions 300, in addition the motor 130 and the speed reduction transmission 180, in addition to the rotary to reciprocal fourth module structure 340 is shown.

Next, FIG. 7 shows the exploded side elevation cross-section dis-assembly view of the self-contained modular rotary/reciprocal/vibratory movement multi-purpose tool apparatus 50 that includes the core first module 90, plus the first auxiliary power second module 635 that is adapted to accommodate a standardized power source 630 from existing manufacturers, the fourth module structure 340 and its output shaft 370, and further the second auxiliary power third module 635 that is adapted to accommodate a standardized power source 630 from existing manufacturers, in addition the motor 130 and the speed reduction transmission 180, in addition to the rotary to reciprocal fourth module structure 340 is shown.

Further, FIG. 8 shows the exploded side elevation cross-section dis-assembly view of the self-contained modular rotary/reciprocal/vibratory movement multi-purpose tool apparatus 50 that includes the core first module 90, plus the first auxiliary power second module 245 and its accessory end portion 255, the fourth module structure 340 and its output shaft 370, and further the second auxiliary power third module 290 and its peripheral end portion 300, in addition the motor 130 and the speed reduction transmission 180, in addition to a chuck rotational vise 600 for the first means 200 for rotational removable engagement is shown.

Continuing, FIG. 9 shows the exploded side elevation cross-section dis-assembly view of the self-contained modular rotary/reciprocal/vibratory movement multi-purpose tool apparatus 50 that includes the core first module 90, plus the first auxiliary power second module 245 and its accessory end portion 255, the fourth module structure 340 and its output shaft 370, and further the second auxiliary power third module 290 and its peripheral end portion 300, in addition the motor 130 and the speed reduction transmission 180, further shown is the fifth means 375 for reciprocating removable engagement, the reciprocating tool 385, and the surrounding sidewall safety shroud 640.

Continuing, FIG. 10 shows the exploded side elevation cross-section dis-assembly view of the self-contained modular rotary/reciprocating/vibratory movement multi-purpose tool apparatus 50 that includes the core first module 90, plus the first auxiliary power second module 245 and its accessory end portion 255, the eighth module 795 right angle rotational drive structure 790 and its input shaft 820 and output shaft 830, and further the second auxiliary power third module 290 and its peripheral end portion 300, in addition the motor 130 and the speed reduction transmission 180.

Next, FIG. 11 shows the exploded side elevation cross-section dis-assembly view of the self-contained modular rotary/reciprocal/vibratory movement multi-purpose tool apparatus 50 that includes the core first module 90, plus the first auxiliary power second module 245 and its accessory end portion 255, the sixth module 670 hammer drill and its input shaft 705 and output shaft 710, and further the second auxiliary power third module 290 and its peripheral end portion 300, in addition the motor 130 and the speed reduction transmission 180.

Further, FIG. 12 shows the exploded side elevation cross-section dis-assembly view of the self-contained modular rotary/reciprocal/vibratory movement multi-purpose tool apparatus 50 that includes the core first module 90, plus the first auxiliary power second module 245 and its accessory end portion 255, the seventh module 755 impact wrench and its input shaft 770 and output shaft 775, and further the second auxiliary power third module 290 and its peripheral end portion 300, in addition the motor 130 and the speed reduction transmission 180.

Further, FIG. 13 shows an exploded side elevation cross-section dis-assembly view of the self-contained modular rotary/reciprocal/vibratory movement multi-purpose tool apparatus 50 that includes the core first module 90, plus the first auxiliary power second module 245 and its accessory end portion 255, the fourth module structure 340 and its output shaft 370, and further the second auxiliary power third module 290 and its peripheral end portion 300, in addition the motor 130 and the speed reduction transmission 180, in addition to the rotary to reciprocal fourth module structure 340 are shown, in addition to the collar structure 1195 that includes a switch 1200 and a light dimmer 1205, the collar is powered from the first module 90 and powers electrical accessory 1185 in the form of an illumination element 1240 that illuminates the article 85.

Continuing, FIG. 14 shows a remote electronic assembly 1270 that is powered from the collar structure 1195, as shown in FIG. 13, in FIG. 14 the remote electronic assembly 1270 can be mounted remote 1260 in relation to the self-contained modular rotary/reciprocal movement multi-purpose tool apparatus 50, wherein the remote electronic assembly 1270 can be an illumination element, or gas detector, motion detector, Bluetooth speaker, and Wi-Fi hotspot.

Next, FIG. 15 shows a first alternative embodiment of the multi-purpose rotary/reciprocal/vibratory movement tool apparatus 845 that has a core second module 850 that includes a motor 890 and energy source 895 that drives a speed reduction transmission 950 that drives the tenth module 1060 that create variable reciprocal movement 1085 thereby causing the core second module 850 to reciprocally vibrate, further shown is the nineth module 1000 that includes a first motor drive 1052 with imbalance element 1051 and in an opposing position along the core percussion axis 865 is the output end portion of the tenth module 1060 that includes the second motor drive 1053 with imbalance element 1051.

Further, FIG. 16 shows the wand 1100 that optionally replaces the second motor 1053 and soft tipped dome massager extension 1055, the wand attaches to the output end portion 1070 that is modified 1062 of the tenth module 1060 to attach to the wand 1100 proximal tube end portion 1115, with the third motor 1054 driving the imbalance element 1051 through a Bowden cable 1105 providing rotary imbalance 1005 and reciprocating movement 1085 at the wand distal 1120 at the soft dome tip 1055.

Moving onward, FIG. 17 shows the bench mount 725 for the core first module 90 that removably engages 730 the core second end portion 100 to the workbench surface 737 or through to a workbench vise 736 to secure the self-contained modular rotary/reciprocal/vibratory movement multi-purpose tool apparatus 50 to the workbench 736 or vise 736 to enable the user to use both hands to manipulate the article 85 without having to manually hold the self-contained modular rotary/reciprocal/vibratory movement multi-purpose tool apparatus 50, such that the first means 200 for removable engagement extends vertically upward.

Next, FIG. 18 shows the bench mount 725 for the core first module 90 that removably engages 730 the peripheral end portion 300 of the second auxiliary power third module 290 that ultimately attaches to the outer surface of the core first module 90 to give an alternate mounting of the self-contained modular rotary/reciprocal/vibratory movement multi-purpose tool apparatus 50 to the workbench surface 737 or through to a workbench vise 736 to secure the self-contained modular rotary/reciprocal/vibratory movement multi-purpose tool apparatus 50 to the workbench 736 or vise 736 to enable the user to use both hands to manipulate the article 85 without having to manually hold the self-contained modular rotary/reciprocal/vibratory movement multi-purpose tool apparatus 50, positioned such that the first means 200 for removable engagement extends horizontally.

Continuing, FIG. 19 shows the multiple reciprocating tool 385 receptacle carriage 660 for the fourth module 340, wherein the receptacle cartridge 660 can hold a variety of reciprocating tools 385 in a circular manner.

Next, FIG. 20 shows the guarded spindle twelfth module 1271 in cross section and an end view that is removably engaged to the core first module 90 at the male thread engagement 1345 to the first end portion 95 of the core first module 90, wherein the inner rigid guard 1295 rotates in a lockable manner via rotation lock 1290, plus the guarded spindle twelfth module 1271 uses a dual sided castellated nut locking ring 1286 that is received into the inner back plate guard 1320 notches 1325 to rotationally lock the safety shroud to the core first module 90, with the safety shroud being operational as a safety shroud for a rotary spindle 445 with the circular saw 445 as shown.

Further, FIG. 21 shows a detailed view from FIG. 20 of the dual sided castellated nut locking ring 1286 that is received into the inner back plate guard 1320 notches 1325 in relation to the core first module 90 to rotationally lock the safety shroud in selected rotational positions

Broadly, in looking at FIGS. 1 to 21, the present invention is the self-contained modular rotary/reciprocal/vibratory movement multi-purpose tool apparatus 50, the multi-purpose tool apparatus 50 is for cutting 55, drilling 60, trimming 65, sanding 70, polishing 75, or massaging 80 utilizing a plurality of tool pieces 81 for work upon an article 85, the multi-purpose tool apparatus 50 includes a core first module 90 that has a core first end portion 95 and an opposing core second end portion 100 with a core longitudinal axis 105 spanning therebetween. The core first module 90 also includes a core surrounding sidewall 110 with a core surrounding sidewall outer surface 115 and an opposing core surrounding sidewall inner surface 120, the first core module 90 further includes a core first module interior 125 that is defined by the core first module surrounding sidewall inner surface 120 and the first 95 and second 100 core end portions, the core first module 90 further includes a motor 130 with an energy source 135 that is disposed within the core first module interior 125, the motor 130 has a motor primary end portion 140 and an opposing motor secondary end portion 145 with a motor rotational axis 150 disposed therebetween, wherein the motor secondary end portion 145 further includes a first plurality of removably engageable electrical communications 151. Wherein the motor 130 further has a body portion 155 that is disposed between the motor primary end portion 140 and the motor secondary end portion 145, the motor body portion 155 further includes a second plurality of removably engageable electrical communications 160 that are disposed upon an external portion 165 of the motor body portion 155.

Wherein, on the multi-purpose tool apparatus 50, the core longitudinal axis 105 and the motor rotational axis 150 are substantially coincident 170 to one another, the motor primary end portion 140 further includes a primary motor output shaft 175 that is rotationally engaged 195 to a speed reduction transmission 180 through a speed reduction transmission input shaft 185, wherein the speed reduction transmission 180 has a speed reduction transmission output shaft 190 that has a first means 200 for rotational removable engagement disposed at the core 90 first end portion 95, the speed reduction transmission 180 is disposed 205 within the core first end portion 95, the motor secondary end portion 145 further includes a direct motor output shaft 210 having a second means 215 for rotational removable engagement disposed at the core second end portion 100. The core first end portion 95 has a third means 220 for removable engagement and the core second end portion 100 has a fourth means 225 for removable engagement, the core surrounding sidewall 110 further includes a first interface 230 that is disposed therethrough from the core surrounding sidewall outer surface 115 to the core surrounding sidewall inner surface 120, the first interface 230 is about an extension axis 235 that is positioned substantially perpendicular 240 to the core longitudinal axis 105.

Optionally for the self-contained modular rotary/reciprocal movement multi-purpose tool apparatus 50, wherein the motor energy source 135 is disposed in a first auxiliary power second module 245, the first auxiliary power second module 245 having a prime end portion 250 and an opposing accessory end portion 255 with a longwise axis disposed therebetween 260. Wherein the prime end portion 255 has a prime end removable engagement 265 that interfaces with the fourth means 225 for removable engagement, the prime end portion 250 further includes a first auxiliary electrical communication structure 270 that is removably engageable to the first plurality of removably engageable electrical communications 151 to operationally provide electrical power to the motor 130, the longwise axis 260 and the longitudinal axis 105 are substantially coincident 275 to one another when the first auxiliary power second module 245 and the core first module 90 are engaged to one another and in a first assembled state 280.

A continuing option for the self-contained modular rotary/reciprocal movement multi-purpose tool apparatus 50, wherein the accessory end portion 255 further includes a first auxiliary container structure 285 that is operational to store the tool pieces 81, see FIGS. 1 to 4 and FIGS. 6 to 18..

Alternatively for the self-contained modular rotary/reciprocal/vibratory movement multi-purpose tool apparatus 50, wherein the motor energy source 135 is disposed in a second auxiliary power third module 290, the second auxiliary power third module 290 having a principal end portion 295 and an opposing peripheral end portion 300 with an arm axis 305 disposed therebetween, wherein the principal end portion 295 has a principal end removable engagement 315 that connects with the first interface 230 at the core surrounding sidewall outer surface 115. The principal end portion 295 further includes a second auxiliary electrical communication structure 320 that is removably engageable to the second plurality of removably engageable electrical communications 160, to operationally provide electrical power to the motor 130, the extension axis 235 and the arm axis 305 are both substantially perpendicular 325 to the longitudinal axis 105 when the second auxiliary power third module 290 and the core first module 90 are engaged to one another in a second assembled state 330, see FIGS. 1 to 4.

Another alternative for the self-contained modular rotary/reciprocal/vibratory movement multi-purpose tool apparatus 50, wherein the peripheral end portion 295 further includes a second auxiliary container structure 335 that is operational to store the tool pieces 86, see FIGS. 1 to 4.

As an alternative embodiment for the self-contained modular rotary/reciprocal/vibratory movement multi-purpose tool apparatus 50, it can further comprise a rotary rotation to reciprocal movement fourth module 340 that includes a fourth module input end portion 345 and an opposing fourth module output end portion 350 with a rotary/reciprocal axis 355 disposed therebetween, further the rotary rotation to reciprocal movement fourth module 340 has an input shaft 360 that is rotationally removably engageable 365 to the first means 200 for rotational engagement. The fourth module input end portion 345 is removably engaged to the third means 220 for removable engagement, further the rotary rotation to reciprocal movement fourth module 340 has a reciprocating output shaft 370 that has a fifth means 375 for reciprocating removable engagement, see in particular FIGS. 1 to 3.

Further included in the alternative embodiment for the self-contained modular rotary/reciprocal/vibratory movement multi-purpose tool apparatus 50, wherein it can further comprise a reciprocating tool 380 that is removably engaged to the fifth means 375 for reciprocating removable engagement that is selected from the group 385 consisting of a reciprocating saw, a hex bit, a T-slot saw, a needle file, a grill brush, a grill gate scraper, a chisel, and a scrapping blade, see FIGS. 1 to 3.

Also included in the alternative embodiment for the self-contained modular rotary/reciprocal/vibratory movement multi-purpose tool apparatus 50, further comprising a rotary spindle fifth module 390 that includes a fifth module input end portion 395 and an opposing fifth module output end portion 400 with a rotary spindle axis 405 disposed therebetween. Further the rotary spindle fifth module 390 has an input shaft 410 that is rotationally removably engageable 415 to the first means 200 for rotational engagement, the fifth module input end portion 395 is removably engaged 420 to the third means 220 for removable engagement 420, further the rotary spindle fifth module output end portion 400 has an output shaft 425 projecting from a perpendicularly 435 oriented disc 430 forming a sixth means 440 for rotational and radial removable engagement, see FIG. 4 in particular.

A further option for the self-contained modular rotary/reciprocal/vibratory movement multi-purpose tool apparatus 50, wherein it can further comprise a rotary spindle tool 445 that is removably engaged 450 to the sixth means 440 for removable engagement that is selected from the group 445 consisting of a circular saw, an angle grinder, an air blower, a needle file, a chain saw, a belt sander, an angle sander, a coffee grinder, a pump, a weed eater, a wire brush, and a torque driver, see in particular FIG. 4.

A continuing option for the self-contained modular rotary/reciprocal/vibratory movement multi-purpose tool apparatus 50, wherein the principal end portion 295 that has the first interface 230 with the core surrounding sidewall outer surface 115 can further comprise a rotary couple 455 that facilitates a one-hundred eighty degree rotation of the principal end portion 295 and the peripheral end portion 300 about the arm axis 305 in a rotationally locking manner creating a first rotational lock 460. The one-hundred eighty degree rotation 465 about the arm axis 305 stopping in a second rotational lock 470, enabling the second auxiliary power third module 290 the option of lockably facing either the core first module 90 first 95 or second 100 end portions. Additionally, the rotary couple 455 has a slip ring architecture 475 to facilitate a plurality of third auxiliary electrical communications 480 at the first interface 230 as between the principal end portion 295 and the core surrounding sidewall 110 outer surface 115 to enable the third auxiliary electrical communications 480 as between the one-hundred eighty degree rotation 485 about the arm axis 305 from the first rotational lock 460 to the second rotational lock 470 and vice versa from the principal end portion 295 to the core surrounding sidewall outer surface 115 to ultimately provide electrical power from the second auxiliary power third module 290 to the motor 130, see FIGS. 1 to 5.

Accordingly, the present invention of the self-contained modular rotary/reciprocal/vibratory movement multi-purpose tool apparatus 50, has been described with some degree of particularity directed to the embodiments of the present invention. It should be appreciated, though; that the present invention is defined by the following claims construed in light of the prior art so modifications or changes may be made to the exemplary embodiments of the present invention without departing from the inventive concepts contained therein.

1. A self-contained modular rotary/reciprocal/vibratory movement multi-purpose tool apparatus, said multi-purpose tool apparatus is for cutting, drilling, trimming, sanding, polishing, or massaging utilizing a plurality of tool pieces for work upon an article, said multi-purpose tool apparatus comprising:
a. a core first module that has a core first end portion and an opposing core second end portion with a core longitudinal axis spanning therebetween, said core first module also includes a core surrounding sidewall with a core surrounding sidewall outer surface and an opposing core surrounding sidewall inner surface, said core module further includes a core first module interior that is defined by said core first module surrounding sidewall inner surface and said first and second core end portions, said core first module further includes a motor with an energy source that is disposed within said core first module interior, said motor has a motor primary end portion and an opposing motor secondary end portion with a motor rotational axis disposed therebetween, wherein said motor secondary end portion further includes a first plurality of removably engageable electrical communications, wherein said motor further has a body portion that is disposed between said motor primary end portion and said motor secondary end portion, said motor body portion further includes a second plurality of removably engageable electrical communications that are disposed upon an external portion of said motor body portion, wherein said core longitudinal axis and said motor rotational axis are substantially coincident to one another, said motor primary end portion further includes a primary motor output shaft that is rotationally engaged to a speed reduction transmission through a speed reduction transmission input shaft, wherein said speed reduction transmission has a speed reduction transmission output shaft that has a first means for rotational removable engagement disposed at said core first end portion, said speed reduction transmission is disposed within said core first end portion, said motor secondary end portion further includes a direct motor output shaft having a second means for rotational removable engagement disposed at said core second end portion, said core first end portion has a third means for removable engagement and said core second end portion has a fourth means for removable engagement, said core surrounding sidewall further includes a first interface that is disposed therethrough from said core surrounding sidewall outer surface to said core surrounding sidewall inner surface, said first interface is about a first extension axis that is positioned substantially perpendicular to said core longitudinal axis, further operationally utilizing a plurality of rotating tools that are removably engaged to said first means via a chuck rotational holding vise for rotational removable engagement that is selected from the group consisting of a drill bits, paddle/flat wood drills, a rotating snow brush, and a hole saw.

2. A self-contained modular rotary/reciprocal/vibratory movement multi-purpose tool apparatus according to claim 1 wherein said motor energy source is disposed in a first auxiliary power second module, said first auxiliary power second module having a prime end portion and an opposing accessory end portion with a longwise axis disposed therebetween, wherein said prime end portion has a prime end removable engagement that interfaces with said fourth means for removable engagement, said prime end portion further includes a first auxiliary electrical communication structure that is removably engageable to said first plurality of removably engageable electrical communications to operationally provide electrical power to said motor, said first auxiliary electrical communication structure is sized and configured to accommodate a plurality of said first auxiliary electrical communication structures in a stacked and nested manner that are electrically removably connected to one another in an electrically parallel electrical communication to further increase the motor run time, said longwise axis and said longitudinal axis are substantially coincident to one another when said first auxiliary power second module and said core first module are engaged to one another and in a first assembled state.

3. A self-contained modular rotary/reciprocal/vibratory movement multi-purpose tool apparatus according to claim 2 wherein said accessory end portion further includes a first auxiliary container structure that is operational to store the tool pieces.

4. A self-contained modular rotary/reciprocal/vibratory movement multi-purpose tool apparatus according to claim 1 wherein said motor energy source is disposed in a second auxiliary power third module, said second auxiliary power third module having a principal end portion and an opposing peripheral end portion with an arm axis disposed therebetween, wherein said principal end portion has a principal end removable engagement that connects with said first interface at said core surrounding sidewall outer surface, said principal end portion further includes a second auxiliary electrical communication structure that is removably engageable to said second plurality of removably engageable electrical communications, said second auxiliary electrical communication structure that is removably engageable to said second plurality of removably engageable electrical communications is sized and configured to accommodate standardized electrical power sources from existing manufacturers to operationally provide electrical power to said motor, said first extension axis and said arm axis are both substantially perpendicular to said longitudinal axis when said second auxiliary power third module and said core first module are engaged to one another in a second assembled state.

5. A self-contained modular rotary/reciprocal/vibratory movement multi-purpose tool apparatus according to claim 4 wherein said peripheral end portion further includes a second auxiliary container structure that is operational to store the tool pieces.

6. A self-contained modular rotary/reciprocal/vibratory movement multi-purpose tool apparatus according to claim 1, further comprising a rotary rotation to variable reciprocal movement fourth module that includes a fourth module input end portion and an opposing fourth module output end portion with a sixteenth means for removable engagement with a rotary/reciprocal axis disposed therebetween, further said rotary rotation to variable reciprocal movement fourth module has an input shaft that is rotationally removably engageable to said first means for rotational engagement, said fourth module input end portion is removably engaged to said third means for removable engagement, further said rotary rotation to variable reciprocal movement fourth module has a reciprocating output shaft that has a fifth means for reciprocating removable engagement, said rotary rotation to variable reciprocal movement fourth module further includes a surrounding sidewall safety shroud to protect external egress into said reciprocating output shaft, said safety shroud is removably engaged to said fourth module output end portion sixteenth means, said rotary rotation to variable reciprocal movement fourth module further includes a multiple reciprocating tool receptacle carriage that manually indexes one reciprocating tool at a time for use.

7. A self-contained modular rotary/reciprocal/vibratory movement multi-purpose tool apparatus according to claim 6, further comprising a reciprocating tool that is removably engaged to said fifth means for reciprocating removable engagement that is selected from the group consisting of a reciprocating saw, a hex bit, a T-slot saw, a needle file, a grill brush, a grill gate scraper, a chisel, a rasp, a drywall file, a razor, a nail file, an emery board, a linear sander, a linear abrasive mesh pad, a sharpening stone, a lock pick, a cheese grater, a meat tenderizer, a needler a scrapping blade, a ice scrapper, a decal eraser, a jig saw, and a burnisher.

8. A self-contained modular rotary/reciprocal/vibratory movement multi-purpose tool apparatus according to claim 1, further comprising a rotary rotation to hammer drill movement combining drill rotation with rapid axial back and forth movement along said motor rotational axis defined as a sixth module that includes a sixth module input end portion and an opposing sixth module output end portion with a rotary/hammer movement axis disposed therebetween, further said rotary rotation to hammer movement sixth module has an input shaft that is rotationally removably engageable to said first means for rotational engagement, said sixth module input end portion is removably engaged to said third means for removable engagement, further said rotary rotation to hammer movement sixth module has a hammer drill output shaft that has a seventh means for said hammer drill removable engagement, wherein operationally said hammer drill utilizes tools that include masonry drill bits and drain cleaning snakes.

9. A self-contained modular rotary/reciprocal/vibratory movement multi-purpose tool apparatus according to claim 1, further comprising a bench mount for said core first module that has said core first end portion and said opposing core second end portion with said core longitudinal axis spanning therebetween, said core first module also includes said core surrounding sidewall with said core surrounding sidewall outer surface and said opposing core surrounding sidewall inner surface, said bench mount is removably engaged to an adapter and then to said core surrounding sidewall inner surface and is adaptable to affixing to a workbench vise or the work bench surface itself, said bench mount is multi-axis fixedly adjustable to accommodate any X, Y, or Z axis position of said core longitudinal axis in relation to the benchtop work surface, this is to operationally allow for hands free use of said multipurpose tool in that said multipurpose tool does not need to be hand held by a user, wherein the user can use both of their hands to hold their article that is being worked on the said multipurpose tool.

10. A self-contained modular rotary/reciprocal/vibratory movement multi-purpose tool apparatus according to claim 1, further comprising a rotary spindle fifth module that includes a fifth module input end portion and an opposing fifth module output end portion with a rotary spindle axis disposed therebetween, further said rotary spindle fifth module has an input shaft that is rotationally removably engageable to said first means for rotational engagement, said fifth module input end portion is removably engaged to said third means for removable engagement, further said rotary spindle fifth module output end portion has an output shaft projecting from a perpendicularly oriented disc forming a sixth means for rotational and radial removable engagement, further said rotary spindle fifth module includes a rotationally lockable removably engageable annular safety shroud for a disc type rotary spindle tool.

11. A self-contained modular rotary/reciprocal/vibratory movement multi-purpose tool apparatus according to claim 10, further comprising a rotary spindle tool that is removably engaged to said sixth means for removable engagement that is selected from the group consisting of a circular saw, an angle grinder, abrasive wheel, an air blower, a circular saw, a needle file, a chain saw, a belt sander, an angle sander, a coffee grinder, a pump, a weed eater, a wire brush, chain saw, and a torque driver.

12. A self-contained modular rotary/reciprocal/vibratory movement multi-purpose tool apparatus according to claim 4 wherein said principal end portion that has said first interface with said core surrounding sidewall outer surface further comprises a rotary couple that facilitates a one-hundred eighty degree rotation of said principal end portion and said peripheral end portion about said arm axis in a rotationally locking manner creating a first rotational lock, said one-hundred eighty degree rotation about said arm axis stopping in a second rotational lock, enabling said second auxiliary power third module the option of lockably facing either said core first module first or second end portions, additionally said rotary couple has a slip ring architecture to facilitate a plurality of third auxiliary electrical communications at said first interface as between said principal end portion and said core surrounding sidewall outer surface to enable said third auxiliary electrical communications as between said one-hundred eighty degree rotation about said arm axis from said first rotational lock to said second rotational lock and vice versa from said principal end portion to said core surrounding sidewall outer surface to ultimately provide electrical power from said second auxiliary power third module to said motor.

13. A self-contained modular rotary/reciprocal/vibratory movement multi-purpose tool apparatus according to claim 1, further comprising a rotational torque control that can be continuous torque control or intermittent rotational torque variance as in the manner of an impact wrench in a seventh module that includes a seventh module input end portion and an opposing seventh module output end portion with a rotational continuous or intermittent torque control disposed therebetween, further said rotational continuous or intermittent torque control seventh module has an input shaft that is rotationally removably engageable to said first means for rotational engagement, said seventh module input end portion is removably engaged to said third means for removable engagement, further said rotational continuous or intermittent torque control seventh module has an output shaft that has a eighth means for continuous or intermittent torque control removable engagement, wherein operationally said rotational continuous or intermittent torque control utilizes tools to be removably engaged to said eighth means that include sockets, ratchets, and wrenches.

14. A self-contained modular rotary/reciprocal/vibratory movement multi-purpose tool apparatus according to claim 1, further comprising a right angle rotational drive with rotational torque control in an eighth module that includes a eighth module input end portion and an opposing eighth module output end portion with a right angle rotational drive with rotational torque control disposed therebetween, further said right angle rotational drive with rotational torque control eighth module has an input shaft that is rotationally removably engageable to said first means for rotational engagement, said eighth module input end portion is removably engaged to said third means for removable engagement, further said right angle rotational drive with rotational torque control eighth module has an output shaft that has a nineth means for torque control removable engagement, wherein operationally said right angle rotational drive with rotational torque control utilizes tools to be removably engaged to said ninth means that include sockets, ratchets, angle grinders, abrasive wheels, chain saw, and wrenches.

15. A self-contained modular rotary/reciprocal/vibratory movement first alternative embodiment multi-purpose tool apparatus, said multi-purpose tool apparatus is for cutting, drilling, trimming, sanding, polishing, or massaging utilizing a plurality of tool pieces for work upon an article, said multi-purpose tool apparatus comprising:
a. a core second module that has a core first end portion and an opposing core second end portion with a core percussion axis spanning therebetween, said core second module also includes a core surrounding sidewall with a core surrounding sidewall outer surface and an opposing core surrounding sidewall inner surface, said core module further includes a core second module interior that is defined by said core second module surrounding sidewall inner surface and said first and second core end portions, said core second module further includes a motor with an energy source that is disposed within said core second module interior, said motor has a motor primary end portion and an opposing motor secondary end portion with a motor rotational axis disposed therebetween, wherein said motor secondary end portion further includes a first plurality of removably engageable electrical communications, wherein said motor further has a body portion that is disposed between said motor primary end portion and said motor secondary end portion, said motor body portion further includes a second plurality of removably engageable electrical communications that are disposed upon an external portion of said motor body portion, wherein said core percussion axis and said motor rotational axis are substantially coincident to one another, said motor primary end portion further includes a primary motor output shaft that is rotationally engaged to a speed reduction transmission through a speed reduction transmission input shaft, wherein said speed reduction transmission has a speed reduction transmission output shaft that has a fourteenth means for rotational removable engagement disposed at said core first end portion, said speed reduction transmission is disposed within said core first end portion, said core first end portion has a twelfth means for removable engagement and said core second end portion has a thirteenth means for removable engagement, said core surrounding sidewall further includes a second interface that is disposed therethrough from said core surrounding sidewall outer surface to said core surrounding sidewall inner surface, said second interface is about a second extension axis that is positioned substantially perpendicular to said core longitudinal axis;
b. a rotary rotation to variable imbalance rotary percussive movement nineth module that includes a nineth module input end portion and an opposing nineth module output end portion with a variable percussive axis disposed therebetween, further said nineth module input end portion includes a fifteenth means for removable engagement, further said variable rotary percussive movement ninth module has a variable rotary percussive movement output shaft that has a fourteenth means for variable rotary movement via a first motor drive with an imbalance element, and percussive movement removable engagement, said rotary rotation to variable rotary reciprocal movement nineth module further includes a soft tip dome shaped massager extension that is removably engaged to said fifthteenth means, to operationally provide massage movement with rotary variable imbalance and percussion movement; and
c. a tenth module for the rotary rotation to variable imbalance rotary percussive movement, for a variable reciprocal movement of said tenth module for the rotary rotation to variable imbalance rotary percussive movement, that includes a tenth module input end portion and an opposing tenth module output end portion with a variable reciprocal axis disposed therebetween including a reciprocating mass with reciprocating movement along said variable reciprocating axis, further said tenth module output end portion includes a twelfth means for removable engagement, further said variable reciprocal movement tenth module has an input shaft that is rotationally removably engageable to an eighteenth means for variable rotary percussive movement removable engagement rotational engagement, said tenth module input end portion is removably engaged to a nineteenth means for removable engagement, further operationally said variable reciprocal movement tenth module variable reciprocating output with rotary variable imbalance percussion output shaft adds reciprocating percussive movement to said second and nineth modules.

16. A self-contained modular rotary/reciprocal/vibratory movement first alternative embodiment multi-purpose tool apparatus according to claim 15, further comprising an eleventh module for said variable rotary percussive movement that has a variable rotary percussive movement output shaft that has said fourteenth means for variable rotary movement via a second motor drive 1053 with said imbalance element and percussive movement removable engagement, the rotary rotation to variable rotary percussive movement eleventh module further includes a soft tip dome shaped massager extension that is removably engaged to a twelfth means to operationally provide massage movement with rotary variable imbalance and percussion movement.

17. A self-contained modular rotary/reciprocal/vibratory movement first alternative embodiment multi-purpose tool apparatus according to claim 16, wherein said soft tip dome shaped massager extension is replaced with a wand that includes a Bowden cable that structurally is defined as a flexible tube that is affixed at each end defined as a flexible tube proximal end portion and an opposing flexible tube distal end portion, wherein disposed within said flexible tube is a loose fitting fine wire rope that has the ability to slide within the flexible tube, thus having the ability to be directly transmitting, pulling, pushing, and turning movements, said fine wire rope having a fine wire rope proximal end portion and an opposing fine wire rope distal end portion, said flexible tube proximal end portion is removably engaged to an altered version of said tenth module output end portion via a twentieth means for removable engagement and said fine wire rope proximal end portion in removably engaged to said altered version of said tenth module variable reciprocating output with rotary via a third motor variable imbalance percussion output shaft that has via said thirteenth means for removable engagement, said flexible tube distal end portion has a fourteenth means for removable engagement and said fine wire rope distal end portion has a fifteenth means for removable engagement, said wand further includes a soft tip dome shaped massager extension having a housing that is being partially disposed about a soft tip dome shaped massager base, wherein said soft tip dome shaped massager base is removably engaged to said fourteenth means for removable engagement, and said soft tip dome shaped massager is removably engaged to said fifteenth means to operationally provide massage movement with variable reciprocating output with rotary variable imbalance percussion movement at said distal end portion of both said flexible tube and said fine wire rope at said soft tipped dome shaped massager forming said wand that allows remote massage from said tenth module.

18. A self-contained modular rotary/reciprocal/vibratory movement second alternative embodiment multi-purpose tool apparatus, said multi-purpose tool apparatus is for cutting, drilling, trimming, sanding, polishing, or massaging utilizing a plurality of tool pieces for work upon an article, said multi-purpose tool apparatus comprising:
a. a core first module that has a core first end portion and an opposing core second end portion with a core longitudinal axis spanning therebetween, said core first module also includes a core surrounding sidewall with a core surrounding sidewall outer surface and an opposing core surrounding sidewall inner surface, said core module further includes a core first module interior that is defined by said core first module surrounding sidewall inner surface and said first and second core end portions, said core first module further includes a motor with an energy source that is disposed within said core first module interior, said energy source further powers an electrical accessory, said motor has a motor primary end portion and an opposing motor secondary end portion with a motor rotational axis disposed therebetween, wherein said motor secondary end portion further includes a first plurality of removably engageable electrical communications, wherein said motor further has a body portion that is disposed between said motor primary end portion and said motor secondary end portion, said motor body portion further includes a second plurality of removably engageable electrical communications that are disposed upon an external portion of said motor body portion, wherein said core longitudinal axis and said motor rotational axis are substantially coincident to one another, said motor primary end portion further includes a primary motor output shaft that is rotationally engaged to a speed reduction transmission through a speed reduction transmission input shaft, wherein said speed reduction transmission has a speed reduction transmission output shaft that has a first means for rotational removable engagement disposed at said core first end portion, said speed reduction transmission is disposed within said core first end portion, said motor secondary end portion further includes a direct motor output shaft having a second means for rotational removable engagement disposed at said core second end portion, said core first end portion has a third means for removable engagement, said core first end portion has a third plurality of electrical accessory removably engageable electrical communications that are disposed upon said third means, and said core second end portion has a fourth means for removable engagement, said core surrounding sidewall further includes a first interface that is disposed therethrough from said core surrounding sidewall outer surface to said core surrounding sidewall inner surface, said first interface is about an extension axis that is positioned substantially perpendicular to said core longitudinal axis, further operationally utilizing a plurality of rotating tools that are removably engaged to said first means via a chuck rotational holding vise for rotational removable engagement that is selected from the group consisting of a drill bits, paddle/flat wood drills, a rotating snow brush, and a hole saw;
b. a collar structure that functions as a switch that includes a light dimmer and power off/on switch that are tethered to one another via an electrical communication, said collar structure has a proximal end portion and an opposing distal end portion, wherein said collar structure proximal end portion interfaces with said third means for removable engagement and said third plurality of electrical accessory removably engageable electrical communications, further said collar structure distal end portion has a seventeenth means for removable engagement and a fourth plurality of electrical accessory removably engageable electrical communications; and
c. an illumination element that is sized and configured to illuminate the article, said illumination element is removably engaged to said collar structure at said seventeenth means for removable engagement and at said fourth plurality of electrical accessory removably engageable electrical communications.

19. A self-contained modular rotary/reciprocal/vibratory movement second alternative embodiment multi-purpose tool apparatus according to claim 18, wherein said illumination element is sized and configured to remotely connect to said collar structure to be removably engaged to said collar structure at said seventeenth means for removable engagement and at said fourth plurality of electrical accessory removably engageable electrical communications, further said illumination element utilizes an extension cord to have a removably engageable remote mount as between said illumination element and a surface.

20. A self-contained modular rotary/reciprocal/vibratory movement second alternative embodiment multi-purpose tool apparatus according to claim 18, wherein said illumination element is modified to include electronic accessories selected from the group consisting essentially of a gas detector, including flammable and toxic, motion detector, Bluetooth speaker, and Wifi hotspot.
